(19) United States
(12) Patent Application Publication
(10) Pub. No.: US 2006/0059437 A1
(43) Pub. Date: Mar. 16, 2006

(54) Interactive pointing guide

(76) Inventor: Kenneth E. Conklin III, Shawnee, KS (US)

Correspondence Address: Kenneth E. Conklin III, 21715 W 56th St, Shawnee, KS, 66218, US

(21) Appl. No.: 10/846,078

(22) Filed: Sep. 14, 2004

(51) Int. Cl. G06F 17/00

(52) U.S. Cl. 715/800; 715/860

(57) ABSTRACT

Maximizing the utilization of screen space by introducing an interactive pointing guide called the Sticky Push. The present interactive pointing guide (IPG) is a software graphical component, which can be implemented in computing devices to improve usability. The present interactive pointing guide has three characteristics: (1) it is interactive, (2) it is movable, and (3) it guides. The present interactive pointing guide includes trigger means that, when activated, cause the graphical user interface tool to display control icons, wherein the control icons cause the graphical user interface tool to perform an operation, selection means for selecting items in a GUI; and magnifying means for magnifying at least a portion of a GUI. An architecture for an interactive pointing guide comprising a content layer, a control layer, and an invisible logic layer which provides liaison between the content and control layers.

Section 1

Introduction

In the 1970s, researchers at Xerox Palo Alto Research Center (PARC) developed the graphical user interface (GUI) and the computer mouse. The potential of these new technologies was realized in the early 1980s when they were implemented in the first Apple computers. Today, the mainstream way for users to interact with desktop computers is with the GUI and mouse.

Because of the success of the GUI on desktop computers, the GUI was implemented in the 1990s on smaller computers called Personal Digital Assistants (PDA) or handheld devices. A problem with this traditional GUI on PDAs is that it requires graphical components that consume valuable screen space. For example, the physical screen size for a typical desktop computer is 1024×768 pixels, and for a handheld device it is 240×320 pixels.

Generally, there are two GUI components on the top and bottom of desktop and handheld screens: the title bar at the top, and the task bar at the bottom. On a typical desktop computer the title bar and task bar account for roughly 7 percent of the total screen pixels. On a PDA the title bar and task bar account for 17 percent of the total screen pixels. This higher percentage of pixels consumed for these traditional GUI components on the PDA reduces the amount of space that could be used for content, such as text. Thus, using a GUI designed for desktop computers on devices with smaller screens poses design and usability challenges. What follows is a description of solutions to these challenges using an interactive pointing guide (IPG) called Sticky Push.

An interactive pointing guide (IPG) is a software graphical component, which can be implemented in computing devices to improve usability. The present interactive pointing guide has three characteristics. First, an interactive pointing guide is interactive. An IPG serves as an interface between the user and the software applications presenting content to the user. Second, the present interactive pointing guide is movable. Users move an IPG on a computer screen to point and select content or to view content the IPG is covering. Third, the present interactive pointing guide (IPG) is a guide. An IPG is a guide because it uses information to aid and advise users in the navigation, selection, and control of content. The first interactive pointing guide developed is called the Sticky Push.

The Sticky Push is used to maximize utilization of screen space on data processing devices. The Sticky Push has user and software interactive components. The Sticky Push is movable because the user can push it around the screen. The Sticky Push is a guide when a user moves it by advising about content and aiding during navigation of content. Finally, the Sticky Push is made up of two main components: the control lens, and the push pad. To implement and evaluate the functionality of the Sticky Push, an application called PDACentric was developed.

PDACentric an embodiment according to the invention. This embodiment is an application programming environment designed to maximize utilization of the physical screen space of PDAs. This software incorporated the Sticky Push architecture in a pen based computing device. The PDACentric application architecture of this embodiment has three functional layers: (1) the content layer, (2) the control layer, and (3) the logic layer. The content layer is a visible layer that displays content the user prefers to view and control with the Sticky Push. The control layer is a visible layer consisting of the Sticky Push. Finally, the logic layer is an invisible layer handling the content and control layer logic and their communication.

This application consists of eight sections. Section 1 is the introduction. Section 2 discusses related research papers on screen utilization and interactive techniques. Section 3 introduces and discusses the interactive pointing guide. Section 4 introduces and discusses the Sticky Push. Section 5 discusses an embodiment of a programming application environment according to an embodiment of the invention called PDACentric which demonstrates the functionality of the Sticky Push. Section 6 discusses the Sticky Push technology and the PDACentric embodiment based on evaluations performed by several college students at the University of Kansas. Sections 7 and 8 further embodiments of Sticky Push technology. There are also two appendices. Appendix A discusses the PDACentric embodiment and Sticky Push technology. Appendix B contains the data obtained from user evaluations discussed in Section 6, and the questionnaire forms used in the evaluations. Appendix C is an academic paper by the inventor related this application which is incorporated herein.

Section 2

Related Work

2.1.1 Semi-transparent Text & Widgets

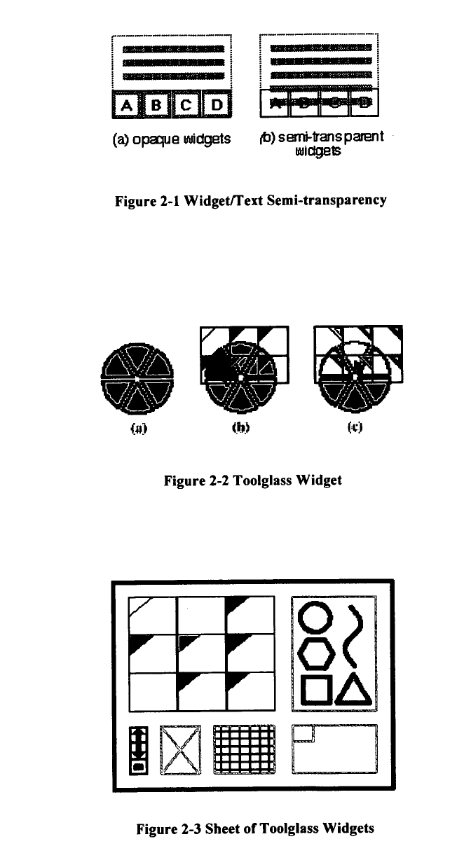

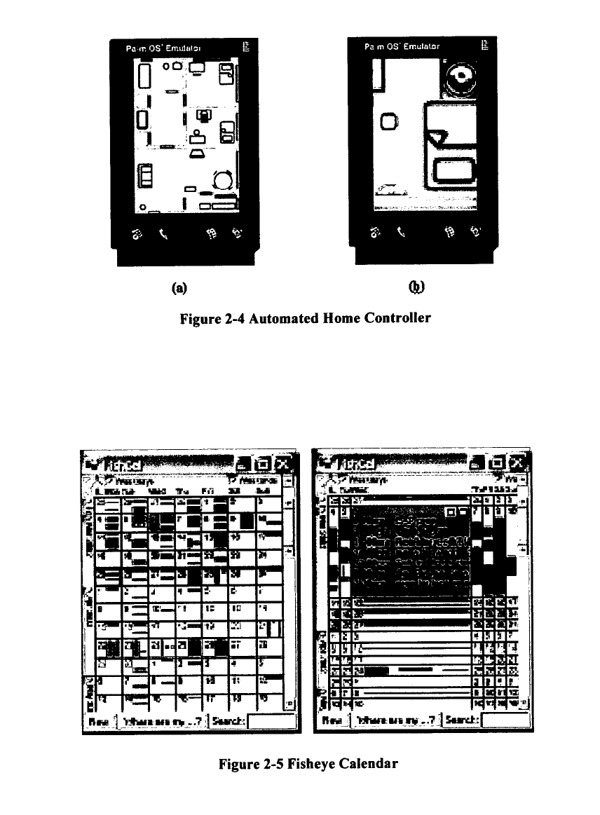

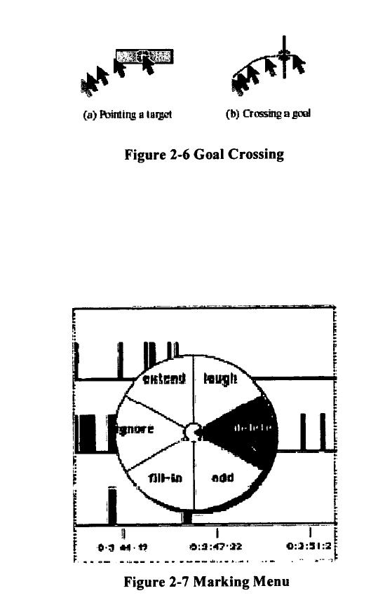

Most user interfaces today display content, such as text, in the same level of transparency as the controls (widgets), such as buttons or icons, shown in FIG. 2-1 (a). In this figure, the text is depicted as three horizontal lines and the widgets are buttons A through D. The widgets in this paradigm consume a large portion of space on limited screen devices. Kamba et. al. discuss a technique that uses semi-transparent widgets and text to maximize the text on a small screen space. This technique is similar to a depth multiplexing—or layered semi-transparent objects, such as menus and windows—strategy introduced by Harrison, et. al. The intent of Kamba et. al. was to allow the text and widgets to overlap with varying levels of semi-transparency. As shown in FIG. 2-1(b), semi-transparency allows a user to maximize text on the screen while having an ability to overlap control components. In FIG. 2-1 (a), the screen is able to display three lines of text and in (b) the screen is able to display five lines of text. One challenge to overlapping text and widgets is it creates potential ambiguity to the user as to whether the user is selecting the semi-transparent text or an overlapping semi-transparent widget. To reduce the ambiguity of user selection, Kamba et. al. introduced a variable delay when selecting overlapping widgets and text to improve the effectiveness of the semi-transparent widget/text model. To utilize the variable delay, the user would engage within a region of the physical screen of the text/widget model. The length of time the user engages in the region determines which “virtual” layer on the physical screen is selected—or receiving the input.

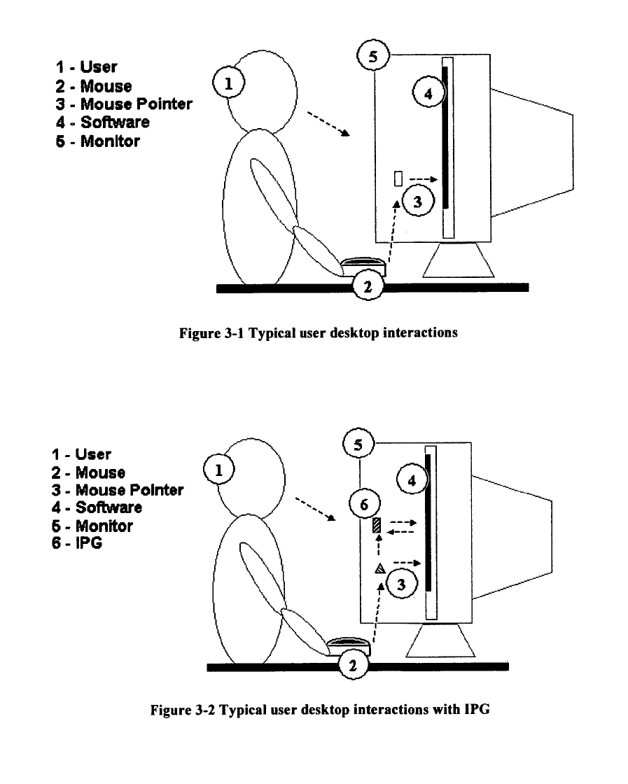

Bier, A., et. al. discusses another interactive semi-transparent tool (widget) called Toolglass. The Toolglass widget consists of semi-transparent “click-through buttons”, which lie between the application and the mouse pointer on the computer screen. Using a Toolglass widget requires the use of both hands. The user controls the Toolglass widget with the non-dominant hand, and the mouse pointer with the dominant hand. As shown in FIG. 2-2, a rectangular Toolglass widget (b) with six square buttons is positioned over a pie object consisting of six equal sized wedges. The user “clicks-through” the transparent bottom-left square button positioned over the upper-left pie wedge object (b) to change the color of the square. Each square “click-through” button has built in functionality to fill a selected object to a specific color. As shown in FIG. 2-3, several Toolglass widgets can be combined in a sheet and moved around a screen. This sheet of widgets, starting clockwise from the upper left, consists of color palette, shape palette, clipboard, grid, delete button and buttons that navigate to additional widgets.

Finally, Bier et. al. discusses another viewing technique called Magic Lens. Magic Lens is a lens that acts as a “filter” when positioned over content. The filters can magnify content like a magnifying lens, and are able to provide quantitatively different viewing operations. For example, an annual rainfall lens filter could be positioned over a certain country on a world map. Once the lens is over the country, the lens would display the amount of annual rainfall.

Like the semi-transparent separations of the text/widget model, the present application programming environment called PDACentric separates control from content in order to maximize the efficiency of small screen space on a handheld device. However, the control and content layers in the PDACentric embodiment are opaque or transparent and there are no semi-transparent components. Unlike the present Sticky Push, the text/widget model statically presents text and widgets in an unmovable state. Similar to Toolglass widgets, the Sticky Push may be moved anywhere within the limits of the screen. The Sticky Push may utilize a “lens” concept allowing content to be “loaded” as an Active Lens. Finally, the Sticky Push may not have a notion of a variable delay between the content and control layers. The variable delay was introduced because of the ambiguous nature of content and control selection due to semi-transparency states of text and widgets.

2.1.2 Sonically-Enhanced Buttons

Brewster discusses how sound might be used to enhance usability on mobile devices. This research included experiments that investigated the usability of sonically-enhanced buttons of different sizes. Brewster hypothesized that adding sound to a button would allow the button size to be reduced and still provide effective functionality. A reduction in button size would create more space for text and other content.

The results of this research showed that adding sound to a button allows for the button size to be reduced. A reduction in button size allows more space for text or other graphic information on a display of a computing device.

Some embodiments of Sticky Push technology incorporate sound to maximize utilization of screen space and other properties and feature of computing devices.

2.13 Zooming User Interfaces

Zooming user interfaces (ZUI) allow a user to view and manage content by looking at a global view of the content and then zoom-in a desired local view within the global view. The user is also able to zoom-out to look at the global view.

As shown in FIG. 2-4, the left picture (a) represents an architectural diagram of a single story house. The user decides to “zoom-in” to a section of the home as shown in the right picture (b). The zoomed portion of the home is enlarged to the maximum size of the screen. Not shown in the figure is the users ability to “zoom-out” of a portion of the home that was zoomed-in. This ability to zoom-in and zoom-out to desired content allows for more efficient screen space utilization.

Another technique similar to ZUIs is “fisheye” viewing. A fisheye lens shows content at the center of the lens with a high clarity and detail while distorting surrounding content away from the center of the lens. A PDA calendar may utilize a fisheye lense to represent dates. It may also provide compact overviews, permit user control over a visible time period, and provide an integrated search capability. As shown in FIG. 2-5, the fisheye calendar uses a “semantic zooming” approach to view a particular day. “Semantic zooming” refers to the technique of representing an object based on the amount of space allotted to the object.

Sticky Push technology embodiments may allow a user to enlarge items such as an icon to view icon content. As used herein, the enlargement feature of some embodiments is referred to as “loading” a lens as the new Active Lens. Once a lens is loaded into the Active Lens, the user may be able to move the loaded lens around the screen. Also, the user may have the ability to remove the loaded lens, which returns the Sticky Push back to its normal—or default—size. The application programming environment of the PDACentric embodiment allows users to create a Sticky Push controllable application by extending an Application class. This Application class has methods to create lenses, called ZoomPanels, with the ability to be loaded as an Active Lens.

2.2 Interactive Techniques

2.2.1 Goal Crossing

Accot and Zhai discuss an alternative paradigm to pointing and clicking with a mouse and mouse pointer called crossing boundaries or goal-crossing. As shown in FIG. 2-6(a), most computer users interact with the computer by moving the mouse pointer over widgets, such as buttons, and clicking on the widget. An alternative paradigm, called crossing-boundaries, is a type of event based on moving the mouse pointer through the boundary of a graphical object, shown in FIG. 2-6(b). Their concept of crossing-boundaries is expanded to say that the process of moving a cursor beyond the boundary of a targeted graphical object is called a goal-crossing task.

The problem with implementing buttons on a limited screen device, such as a PDA, is that they consume valuable screen real estate. Using a goal-crossing technique provides the ability to reclaim space by allowing the user to select content based on crossing a line that is a few pixels in width.

Ren conducted an interactive study for pen-based selection tasks that indirectly addresses the goal-crossing technique. The study consisted of comparing six pen-based strategies. It was determined the best strategy was the “Slide Based” strategy. As Ren describes, this strategy is where the target is selected at the moment the pen-tip touches the target. Similar to the “Slide Based” strategy, goal-crossing is based on sliding the cursor or pen through a target to activate an event.

The goal-crossing paradigm was incorporated into the Sticky Push to reclaim valuable screen real estate. This technique was used to open and close “triggers” and to select icons displayed in the Trigger Panels of the Sticky Push.

2.2.2 Marking Menus

Shown in FIG. 2-7 is a marking menu where the user has selected the delete wedge in the pie menu. This figure shows the marking menu as an opaque graphical component that hides the content below it. The marking menu can be made visible or invisible.

An advantage to the marking menu is the ability to place it in various positions on the screen. This allows the user to decide what content will be hidden by the marking menu when visible. Also, controls on the marking menu can be selected without the marking menu being visible. This allows control of content without the content being covered by the marking menu.

The Sticky Push is similar to the marking menu in that it can be moved around the screen in the same work area as applications, enables the user to control content, and is opaque when visible. However, the present Sticky Push is more flexible and allows the user to select content based on pointing to the object. Moreover, the user is able to determine what control components are visible on the Sticky Push.

Section 3

Interactive Pointing Guide (IPG)

The present interactive pointing guide has three characteristics: (1) it's interactive, (2) it's movable and (3) it's a guide. An interactive pointing guide (IPG) is similar to a mouse pointer used on a computer screen. The mouse pointer and IPG are visible to and controlled by a user. They are able to move around a computer screen, to point and to select content. However, unlike a mouse and mouse pointer, an IPG has the ability to be aware of its surroundings, to know what content is and isn't selectable or controllable, to give advice and to present the user with options to navigate and control content. Interactive pointing guides can be implemented in any computing device with a screen and an input device.

The remainder of this section describes the three interactive pointing guide (IPG) characteristics.

3.1 Interactive

The first characteristic of the present interactive pointing guide is that it is interactive. An IPG is an interface between the user and the software applications presenting content to the user. The IPG interacts with the user by responding to movements or inputs the user makes with a mouse, keyboard or stylus. The IPG interacts with the software applications by sending and responding to messages. The IPG sends messages to the software application requesting information about specific content. Messages received from the software application give the IPG knowledge about the requested content to better guide the user.

To understand how an IPG is interactive, two examples are given. The first example shows a user interacting with a software application on a desktop computer through a mouse and mouse pointer and a monitor. In this example the mouse and its software interface know nothing about the applications. The applications must know about the mouse and how to interpret the mouse movements.

In the second example, we extend the mouse and mouse pointer with an IPG and show how this affects the interactions between the user and the software application. In contrast to the mouse and mouse pointer and to its software interface in the first example, the IPG must be implemented to know about the applications and the application interfaces. Then it is able to communicate directly with the applications using higher-level protocols.

### EXAMPLE 1

### User Interaction Without IPG

A typical way for a user to interact with a desktop computer is with a mouse as input and a monitor as output. The monitor displays graphical content presented by the software application the user prefers to view, and the mouse allows the user to navigate the content on the screen indirectly with a mouse pointer. This interaction can be seen in FIG. 3-1. Users (1) view preferred content presented by software (4) on the computer monitor (5). To interact with the software, the user moves, clicks or performs a specific operation with the mouse (2). Mouse movements cause the computer to reposition the mouse pointer over the preferred content (3) on the computer. Finally, mouse operations, such as a mouse click, cause the computer to perform a specific task at the location the mouse pointer is pointing. The mouse pointer has limited interactions with the content presented by the software application. These interactions include clicking, dragging, entering, exiting and pressing components. A mouse pointer's main function is to visually correlate its mouse point on the screen with mouse movements and operations performed by the user.

### EXAMPLE 2

### User Interaction With IPG

Implementing an IPG into the typical desktop computer interaction can be seen in FIG. 3-2. Users (1) view preferred content presented by software (4) on the computer monitor (5). To interact with the software, the user moves, clicks or performs a specific operation with the mouse (2). Mouse movements cause the computer to reposition the mouse pointer over the preferred content (3) on the computer. The IPG is involved at this step.

At this step the user can decide to interact with the IPG (6) by selecting the IPG with the mouse pointer. If the IPG is not selected, the user interacts with the desktop as in FIG. 3-1. As shown in FIG. 3-2, when the user selects the IPG, it moves in unison with mouse movements, acts like a mouse pointer and performs operations on the software allowed by the IPG and the software. This is accomplished by exchanging messages with the software presenting the content.

To achieve this interaction between the IPG and software, the IPG must be specifically designed and implemented to know about all the icons and GUI components on the desktop, and the software programs must be written to follow IPG conventions. For instance, IPG conventions may be implemented with the Microsoft [16] or Apple [2] operating system software or any other operating system on any device utilizing a graphical user interfaces (GUI). If the IPG is pointing to an icon on the computer screen, the IPG can send the respective operating system software a message requesting information about the icon. Then the operating system responds with a message containing information needed to select, control and understand the icon. Now the IPG is able to display to the user information received in the message. This is similar to tool-tips used in Java programs or screen-tips used in Microsoft products. Tool-tips and screen-tips present limited information to the user, generally no more then a line of text when activated. An IPG is able to give information on an icon by presenting text, images and other content not allowed by tool-tips or screen-tips. Finally, the IPG is not intended to replace tool-tips, screen-tips or the mouse pointer. It is intended to extend its capabilities to enhance usability.

3.2 Movable

The second characteristic of the present interactive pointing guide is that it's movable. Users move an IPG on a computer screen to point and select content or to view content the IPG is covering.

As mentioned in the previous section, an IPG extends pointing devices like a mouse pointer. A mouse pointer is repositioned on a computer screen indirectly when the user moves the mouse. The mouse pointer points and is able to select the content on the computer screen at which it is pointing. In order for an IPG to extend the mouse pointer capabilities of pointing and selecting content on the computer screen, it must move with the mouse at the request of the user.

Another reason why an IPG is movable is it could be covering up content the user desires to view. The size, shape and transparency of an IPG are up to the software engineer. Some embodiments of the present invention include an IPG that at moments of usage is a 5-inch by 5-inch opaque square covering readable content. In order for the user to read the content beneath such an IPG, the user must move it. Other embodiments include an IPG of varying sizes using various measurements such as centimeters pixels and screen percentage.

Finally, moving an IPG is not limited to the mouse and mouse pointer. An IPG could be moved with other pointing devices like a stylus or pen on pen-based computers, or with certain keys on a keyboard for the desktop computer. For instance, pressing the arrow keys could represent up, left, right and down movements for the IPG. A pen-based IPG implementation called the Sticky Push is presented in Section 4.

3.3 Guide

The third characteristic of the present interactive pointing guide (IPG) is that it is a guide. An IPG is a guide because it uses information to aid and advise users in the navigation, selection and control of content. An IPG can be designed with specific knowledge and logic or with the ability to learn during user and software interactions (refer to interactive). For example, an IPG might guide a user in the navigation of an image if the physical screen space of the computing device is smaller than the image. The IPG can determine the physical screen size of the computing device on which it is running (e.g., 240×320 pixels). When the IPG is in use, a user might decide to view an image larger than this physical screen size (e.g. 500×500 pixels). Only 240×320 pixels are shown to the user because of the physical screen size. The remaining pixels are outside the physical limits of the screen. The IPG learns the size of the image when the user selects it and knows the picture is too large to fit the physical screen. Now the IPG has new knowledge about the picture size and could potentially guide the user in navigation of the image by scrolling the image up, down, right, or left as desired by the user.

3.4 Interactive Pointing Guide Summary

The present interactive pointing guide has three characteristics: (1) it is interactive, (2) it is movable and (3) it is a guide. The IPG is interactive with users and software applications. An IPG is movable to point and select content and to allow the user to reposition it if it is covering content. Finally, an IPG is a guide because it aids and advises users in the selection, navigation and control of content. To demonstrate each characteristic and to better understand the IPG concept a concrete implementation called the Sticky Push was developed. This is the subject of the next section.

Section 4

The Sticky Push: An Interactive Pointing Guide

The Sticky Push is a graphical interactive pointing guide (IPG) for computing devices. Like all interactive pointing guides, the Sticky Push is interactive, movable and a guide. The Sticky Push has user and software interactive components. It is movable since the user can push it around the physical screen. The Sticky Push is a guide when a user moves it by advising about content and aiding during navigation of content.

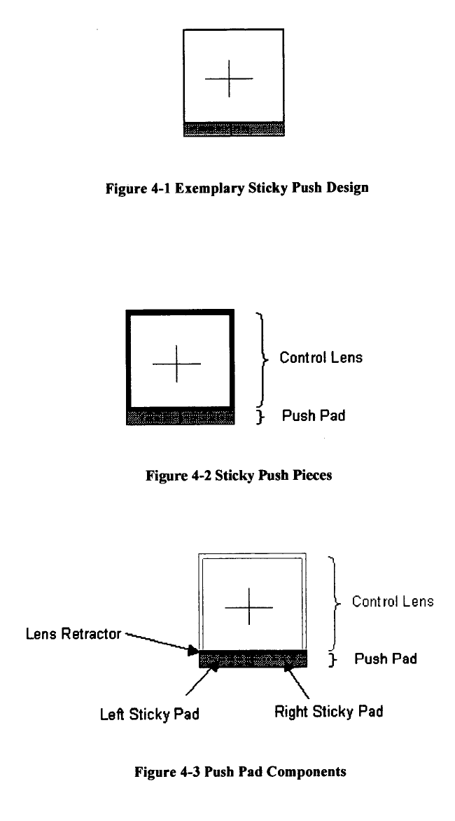

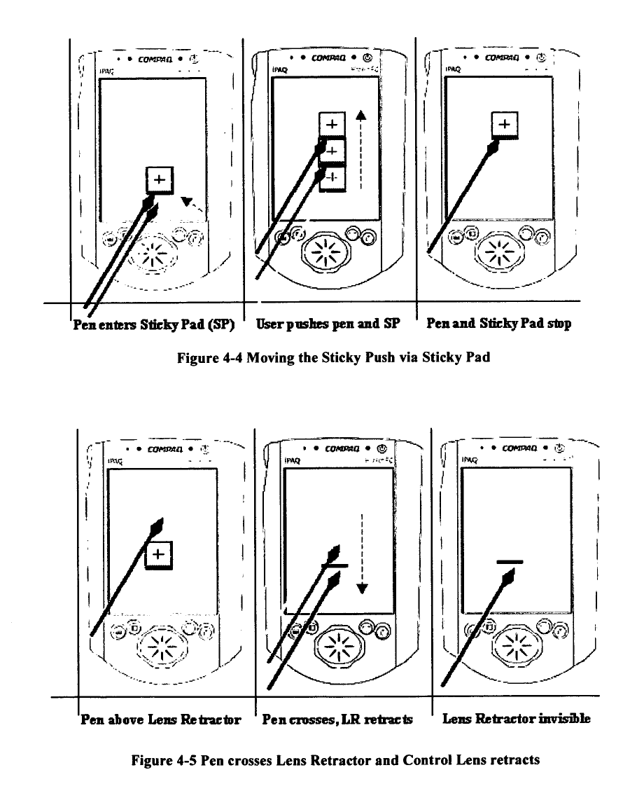

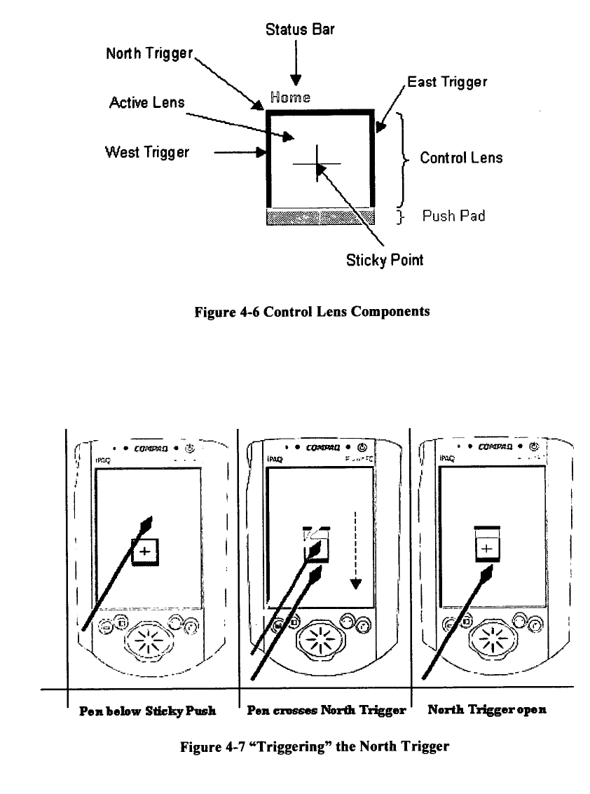

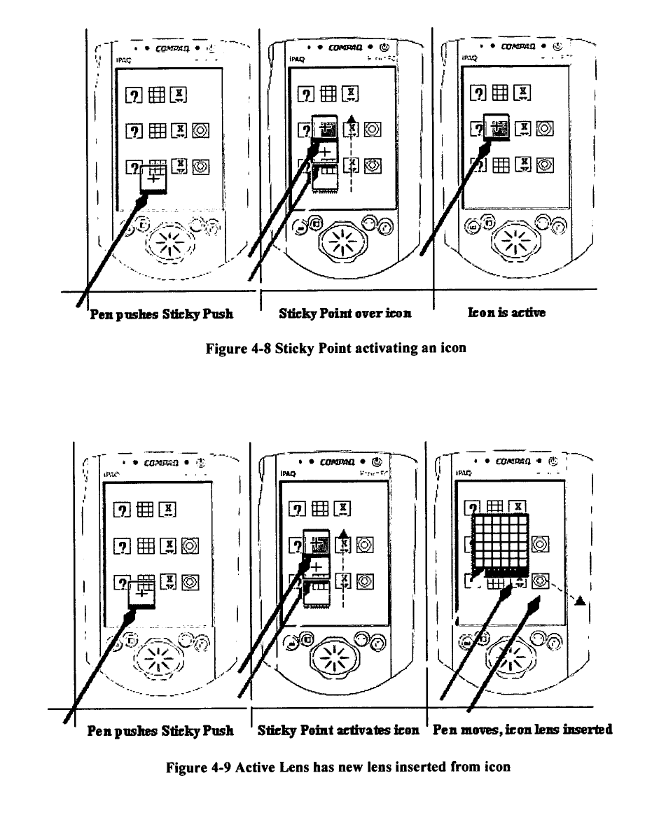

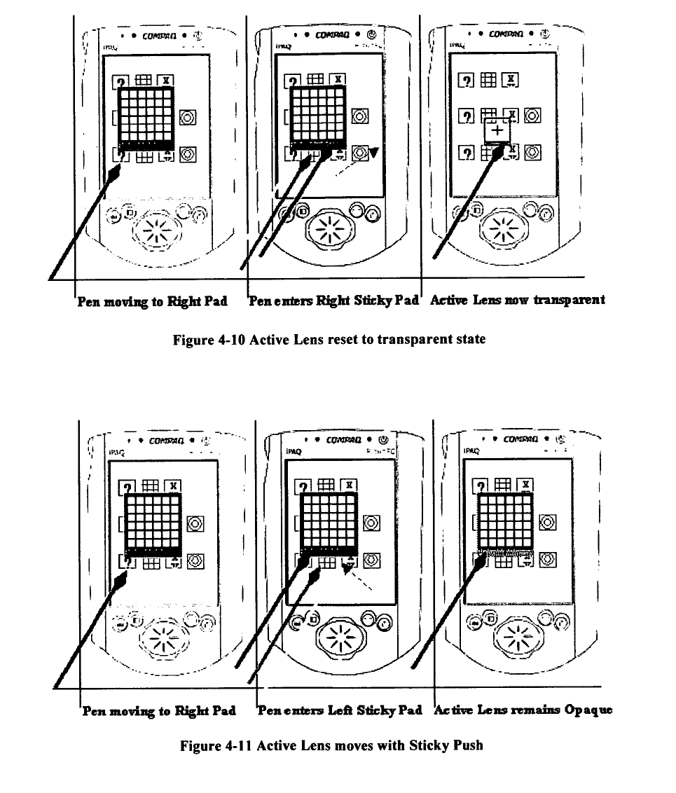

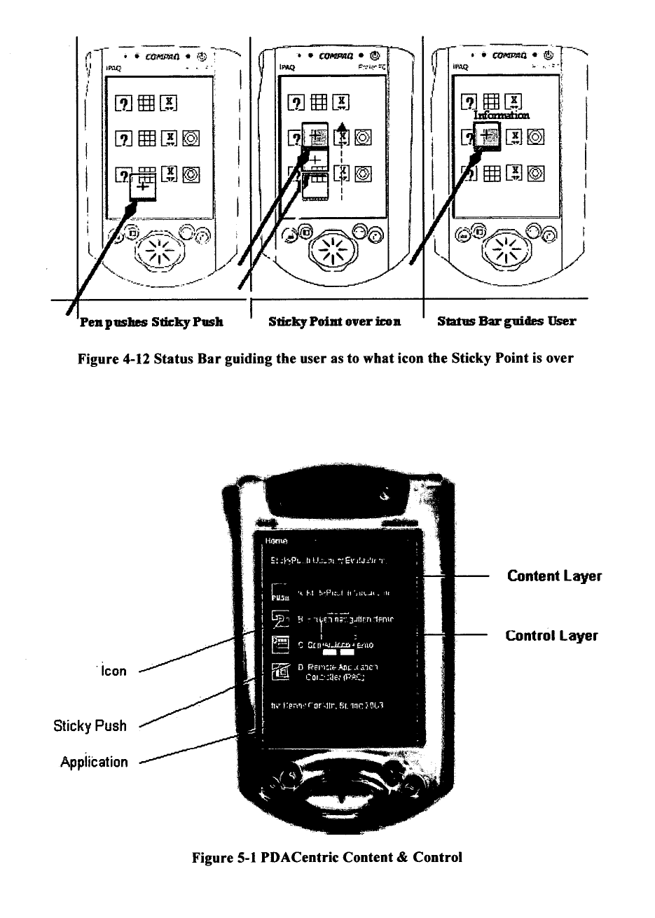

An exemplary design of one Sticky Push embodiment can be seen in FIG. 4-1. This Sticky Push embodiment includes a rectangular graphical component. It is intended to be small enough to move around the physical screen limits of a handheld device.

As shown in FIG. 4-2, the Sticky Push footprint is split into two pieces called the Push Pad and the Control Lens. The Push Pad is the lower of the two pieces and provides interactive and movable IPG characteristics to the Sticky Push. Its function is to allow the user to move, or push the Sticky Push around the screen with a stylus as input. The Push Pad also has a feature to allow the user to retract the Control Lens. Components of the Push Pad include Sticky Pads and the Lens Retractor.

The upper portion of the Sticky Push is the Control Lens, which provides interactive and guide IPG characteristics to the Sticky Push. The Control Lens is attached to the Push Pad above the Lens Retractor. Components of the Control Lens include the North Trigger, East Trigger, West Trigger, Sticky Point, Active Lens and Status Bar.

The next sections in this section discuss the function of each architectural piece of the Sticky Push and how they relate to the characteristics of an interactive pointing device.

4.1 Push Pad

The Push Pad is a graphical component allowing the Sticky Push to be interactive and movable by responding to user input with a stylus or pen. The Push Pad is a rectangular component consisting of two Sticky Pads, Right and Left Sticky Pads, and the Lens Retractor. Refer to FIG. 4-3.

The main function of the Push Pad is to move, or push, the Sticky Push around the screen by following the direction of user pen movements. Another function is to retract the Control Lens to allow the user to view content below the Control Lens.

4.1.1 Sticky Pad

A Sticky Pad is a rectangular component allowing a pointing device, such as a stylus, to “stick” into it. Refer to FIG. 4-3. For instance, when a user presses a stylus to the screen of a handheld device and the stylus Slide Touches the boundaries of a Sticky Pad, the stylus will appear to “stick” into the pad, i.e. move in unison with the pen movements. Since the Sticky Pad is connected to the Push Pad and ultimately the Sticky Push, the Sticky Push and all its components move in unison with the pen movements. The Sticky Push name was derived from this interaction of the pen “Slide Touching” a Sticky Pad, the pen sticking in the Sticky Pad, and the pen pushing around the Sticky Pad and all other components. This interaction of the stylus “sticking” into the Sticky Pad and the Sticky Push being pushed, or moved, in unison with the stylus provides the Sticky Push with the IPG characteristics of interactive, and movable.

An example of how a user presses a pen to the screen of a handheld and moves the Sticky Push via the Sticky Pad can be seen in FIG. 4-4. In the first frame, the user presses the pen on the screen and moves the pen into the Left Sticky Pad. The Sticky Pad realizes the pen is stuck into its boundaries and moves in unison with the pen in the middle frame. Finally, in frame 3, the pen and Sticky Push stop moving. This interaction between pen and Sticky Push make the pen appear to push the Sticky Push around the screen . . . hence the name Sticky Push.

Any number of Sticky Pads could be added to the Sticky Push. For this implementation, only the Right and Left Sticky Pads were deemed necessary. Both the Right and Left Sticky Pads are able to move the Sticky Push around the handheld screen. Their difference is the potential interactive capabilities with the user. The intent of having multiple Sticky Pads is similar to having multiple buttons on a desktop mouse. When a user is using the desktop mouse with an application and clicks the right button over some content, a dialog box might pop up. If the user clicks the left button on the mouse over the same content a different dialog box might pop up. In other words, the right and left mouse buttons when clicked on the same content may cause different responses to the user. The Sticky Pads were implemented to add this kind of different interactive functionality to produce different responses. The Active Lens section below describes one difference in interactivity of the Right and Left Sticky Pads.

4.1.2 Lens Retractor

Refer to FIG. 4-3, the Lens Retractor is a rectangular graphical component allowing the Sticky Push to respond to stylus input by the user. When the user moves the stylus through the boundaries of the Lens Retractor—or goal-crosses, it retracts the Control Lens and all surrounding components attached to the Control Lens, making them invisible. If the Control Lens and surrounding components are not visible when the user goal-crosses the pen through the boundaries of the Lens Retractor, then the Lens Retractor makes the Control Lens components visible.

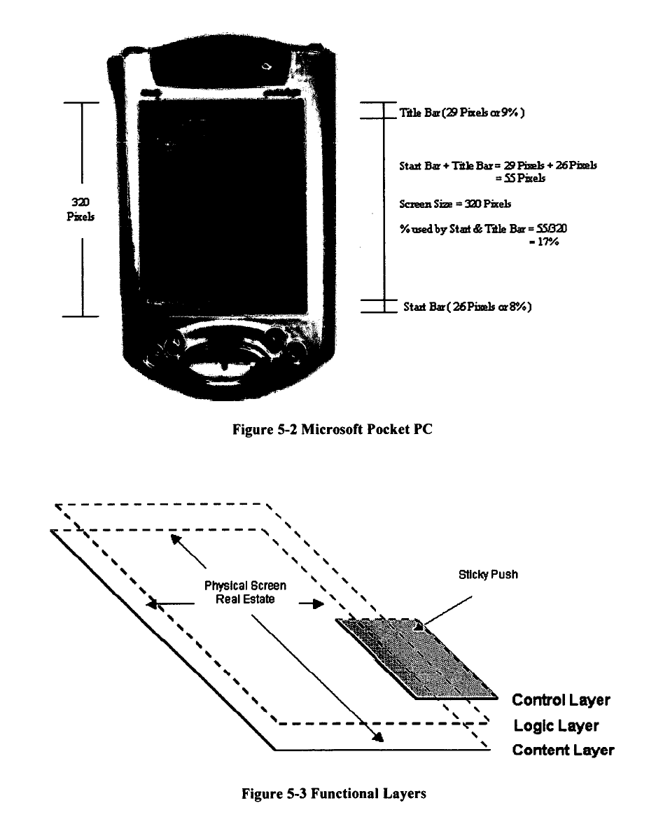

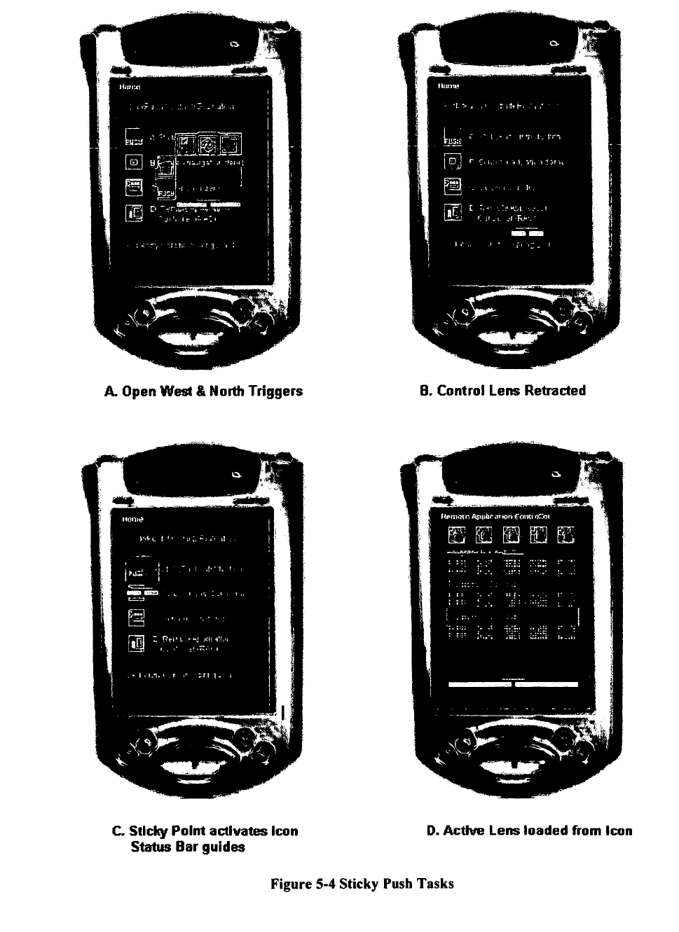

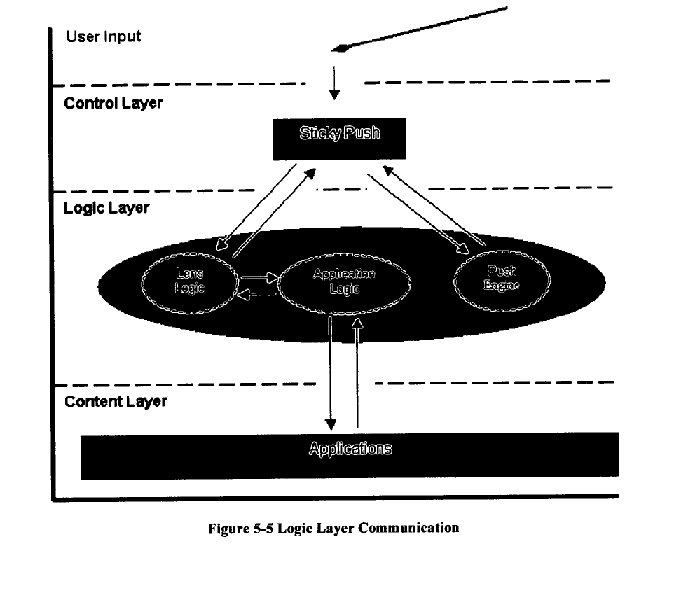

As shown in FIG. 4-5, the user starts the pen above the Sticky Push in frame 1. Then the user moves the pen down and goal-crosses the pen through the boundaries of the Lens Retractor in frame 2. The Lens Retractor recognizes the pen goal-crossed through its boundaries in frame 3 and retracts the Control Lens. Now the only visible component of the Sticky Push is the Push Pad. To make the Control Lens visible again, the user moves the pen to goal-cross through the Lens Retractor. Since the Control Lens is retracted, the Control Lens will expand and become visible again.

The Push Pad is a component of the Sticky Push allowing it to be movable and interactive. Connected above the Push Pad is the upper piece of the Sticky Push called the Control Lens.

4.2 Control Lens

The Control Lens is a rectangular graphical component allowing the Sticky Push to be interactive and a guide. As shown in FIG. 4-6, the Control Lens consists of six components including the North Trigger, East Trigger, West Trigger, Active Lens, Sticky Point, and Status Bar. The Control Lens can be visible, or not depending on whether a user retracts the lens by goal-crossing through the Lens Retractor (refer to Lens Retractor above). As its name implies, the Control Lens provides all control of content associated with an application via the Sticky Push.

The North Trigger, East Trigger and West Trigger provide the same interactive and guide functionality. They present a frame around the Active Lens and hide selectable icons until they are “triggered”. The ability to hide icons gives the user flexibility in deciding when the control components should be visible and not visible.

The Sticky Point knows what content is controllable and selectable when the Sticky Point crosshairs are in the boundaries of selectable and controllable content. The Sticky Point gives the Sticky Push the ability to point to content.

The Active Lens is an interactive component of the Control Lens. It is transparent while the user is selecting content with the Sticky Point. The user can “load” a new lens into the Active Lens by selecting the lens from an icon in an application. This will be discussed in the Active Lens section.

The Status Bar is a guide to the user during the navigation and selection of content. The Status Bar is able to provide text information to the user about the name of icons or any other type of content.

Each component of the Control Lens is described in this section. We begin with the Triggers.

4.2.1 Triggers

The Control Lens has three main triggers: the North Trigger, the East Trigger, and the West Trigger. A “trigger” is used to define the outer boundary of the Active Lens and to present hidden control components when “triggered”. The intent of the trigger is to improve control usability by allowing the users to determine when control components are visible and not visible. When control components are not visible, the triggers look like a frame around the Active Lens. When a trigger is “triggered”, it opens up and presents control icons the user is able to select.

Triggers are able to show viewable icons if the pen “triggers” or goal-crosses through the boundaries of the respective trigger component to activate or “trigger” it. For instance, refer to FIG. 4-7.

In frame 1 of FIG. 4-7, the user presses the handheld screen above the Sticky Push. Then in frame 2 the user directs the pen from above the Sticky Push downwards and goal-crosses the North Trigger. In frame 3 the North Trigger recognized the pen goal-crossed through its boundaries and activated or was “triggered” to present the hidden control components. The control components will remain visible until the North Trigger is triggered again. If a trigger is open and is “triggered” or activated, the trigger will hide its respective control components. If a trigger is closed and is “triggered” or activated, the trigger will show its respective control components. Each trigger has a specific role, which will be described in Section 6.

4.2.2 Sticky Point

The Sticky Point is similar to a mouse pointer or cursor in that it is able to select content to be controlled. The Sticky Point interacts with the software application by sending and responding to messages sent to and from the software application. The Sticky Point sends information about its location. The application compares the Sticky Point location with the locations and boundaries of each icon. If an icon boundary is within the location of the Sticky Point the application activates the icon. For example refer to FIG. 4-8.

In FIG. 4-8, the user is pushing the Sticky Push in frame 1. In frame 2, the user pushes the Sticky Push where the Sticky Point is within the boundaries of a selectable icon. The Sticky Point sends the application its location. The software application responds by activating the icon. In frame 3, the icon remains active as long as the Sticky Point is in its boundaries.

4.2.3 Active Lens

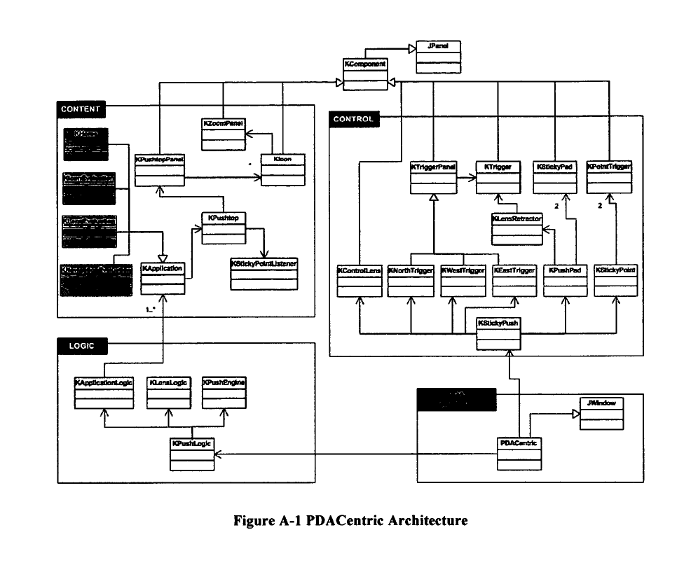

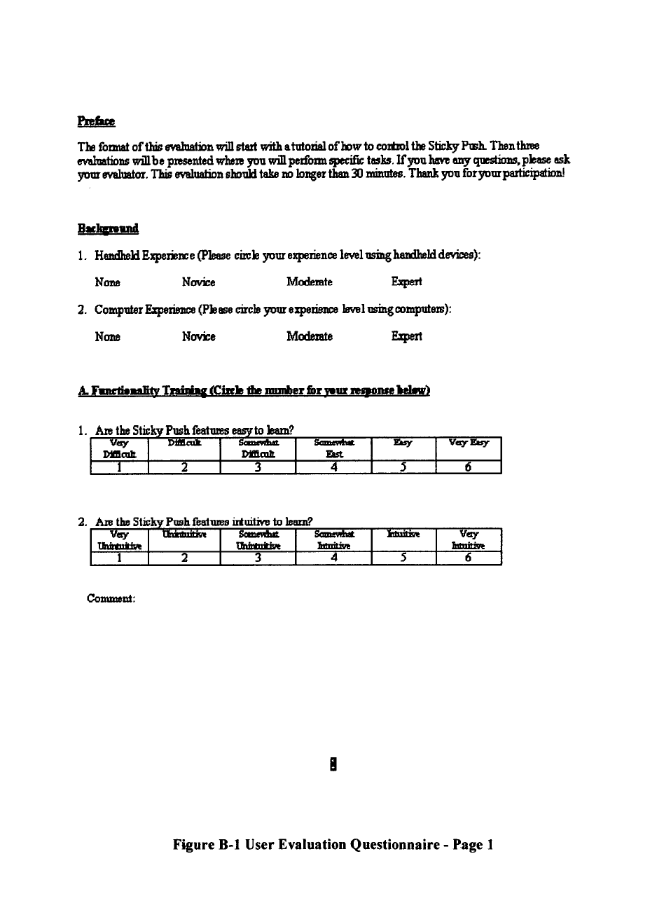

The Active Lens is a graphical component with the ability to be transparent, semitransparent or opaque. A purpose of the Triggers is to frame the Active Lens when it is transparent to show its outer boundaries. The Active Lens is transparent when the user is utilizing the Sticky Point to search, point to, and select an icon. Icons are selectable if they have an associated “lens” to load as the new Active Lens, or if they are able to start a new program. When the user selects an icon with a loadable lens, the icon's associated lens is inserted as the new Active Lens. Refer to FIG. 4-9.

FIG. 4-9 shows a user moving the Sticky Push and selecting an icon to load the icon's associated lens as the Active Lens. Frame 1 shows the user moving the Sticky Push. Frame 2 shows the user pushing the Sticky Push upward and positioning the Sticky Point over a selectable icon. FIG. 3 shows the user lifting up the pen from the Sticky Pad. This interaction of the user removing the pen from the Sticky Pad, or releasing the pen, while the Sticky Point is in the boundaries of a selectable icon shows the Sticky Push will respond by loading the icon's lens as the new opaque Active Lens. The Control Lens in frame 3 expanded to accommodate the size of the new Active Lens. Also, all associated components of the Sticky Push resized to accommodate the new dimensions of the Active Lens. Now the user can place the pen into the new Active Lens and control the Active Lens component.

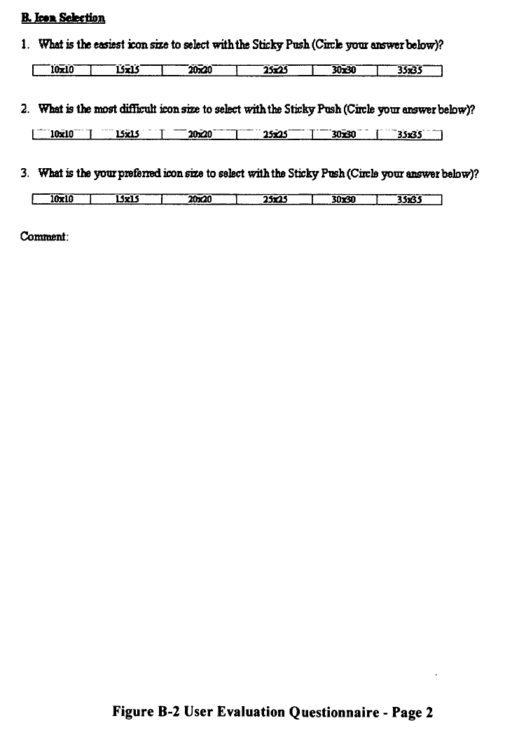

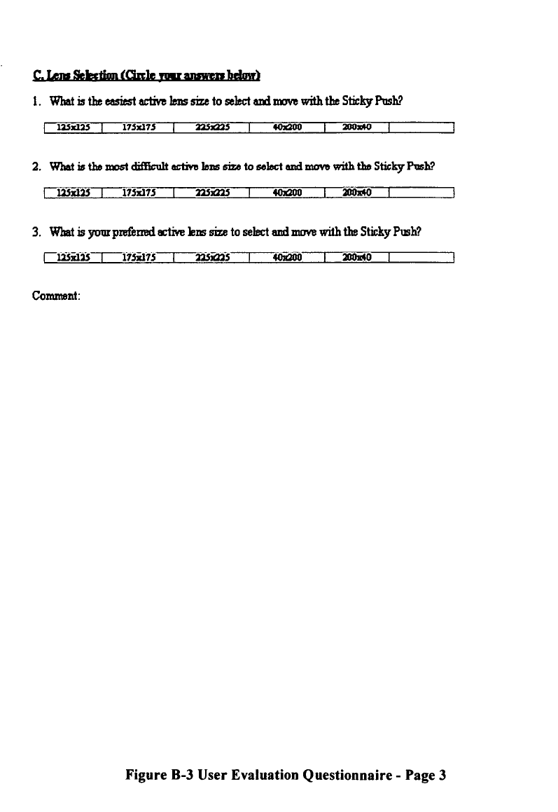

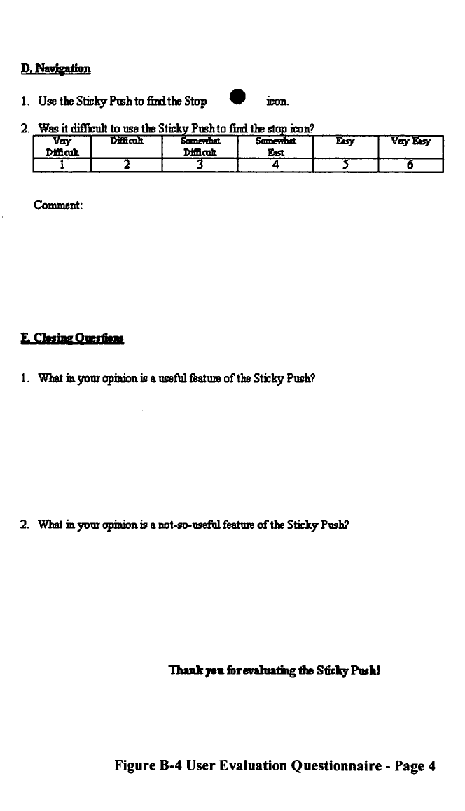

The user can return the Active Lens to the default transparent state by removing the opaque lens. Beginning with frame 1 of FIG. 4-10, the active lens is opaque with a controllable lens loaded as the Active Lens. In frame 2, the user removes the opaque lens by moving the pen into the Right Sticky Pad. The Control Lens has built in logic to know that if the user enters the Right Sticky Pad and there is an opaque Active Lens, then the opaque Active Lens is to be removed and the Active Lens is to return to its default transparent state. When the user decides to move the Sticky Push again, the Active Lens is transparent allowing the Sticky Point to enter the boundaries of icons, shown in frame 3. Conversely, if the user does not decide to remove the opaque Active Lens, but wants to move the Sticky Push with the opaque Active Lens, then a new scenario applies.

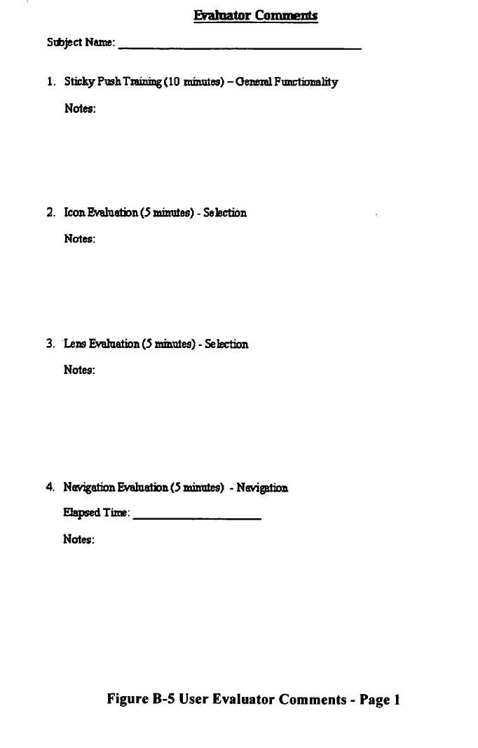

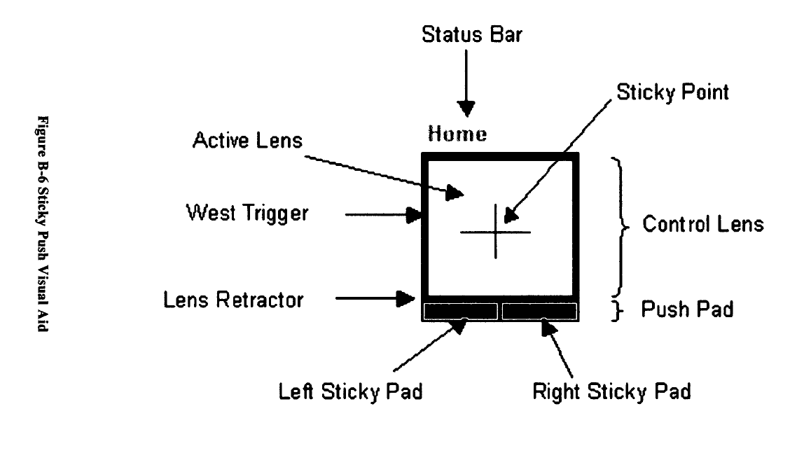

FIG. 4-11 shows the user moving the Sticky Push with the Active Lens opaque. Frame 1 shows the user placing the pen below the Left Sticky Pad. Frame 2 shows the pen entering the left Sticky Pad. The Control Lens has built in logic to know that if the user enters the Left Sticky Pad and there is an opaque Active Lens, then the opaque lens is NOT to be removed, shown in frame 3. This allows the Active Lens to be opaque and be repositioned around the screen with the Sticky Push.

4.2.4 Status Bar

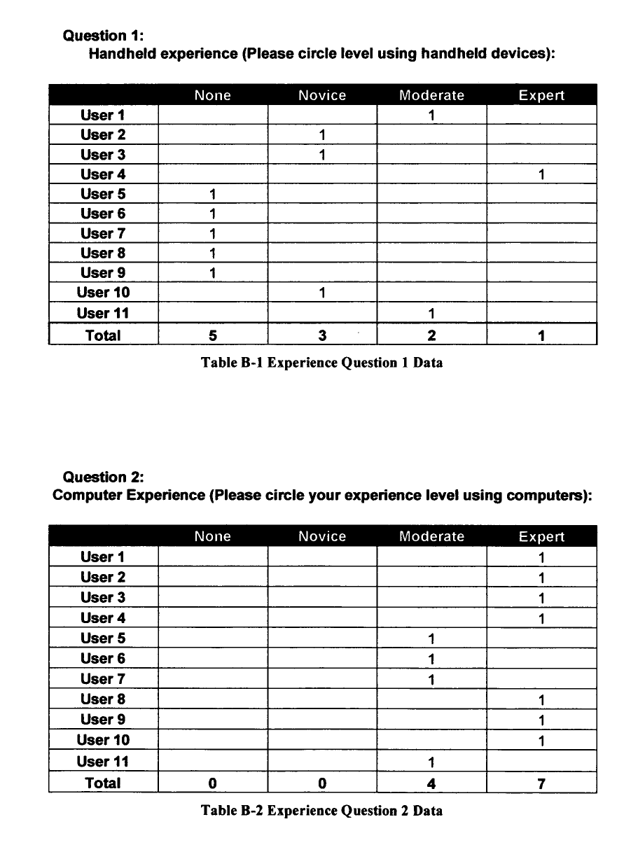

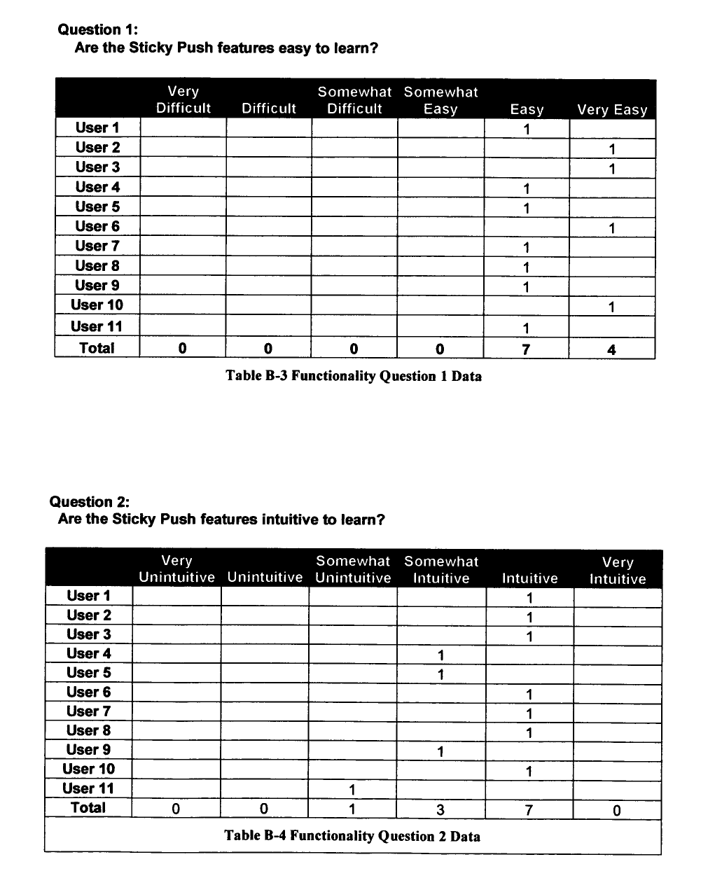

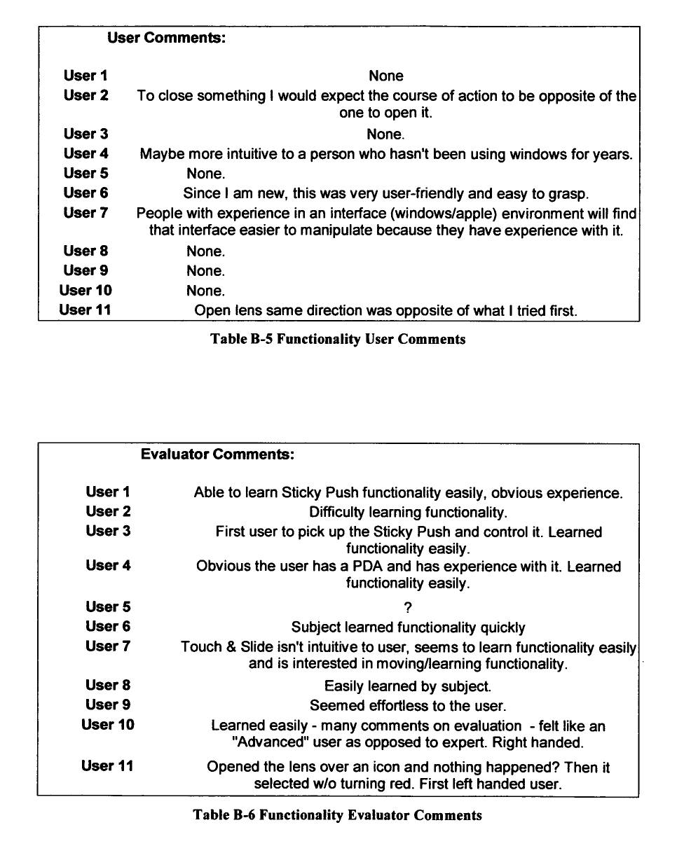

The Status Bar is a component with the ability to display text corresponding to content and events, such as starting a program. The Status Bar guides the user by providing text information on points of interest. Refer to FIG. 4-12.

FIG. 4-12 frame 1 shows a user with a pen in the Left Sticky Pad of the Sticky Push. In frame 2, the user pushes the Sticky Push upward over an icon. The Sticky Point interacts with the application requesting information about the icon in whose boundaries it lies. In frame 3, the Sticky Point sends this information received from the application to the Status Bar, which displays the text of the icon's name, or “Information”.

4.3 Sticky Push Summary

The Sticky Push is a graphical interactive pointing guide (IPG) for pen-based computing devices. Its architecture is divided into two pieces called the Push Pad and the Control Lens. The Push Pad provides the Sticky Push with the IPG characteristics of movable and interactive. It is made up of the Right Sticky Pad, Left Sticky Pad, and Lens Retractor. The Control Lens provides the characteristics of interactive and guide. It is made up of the North Trigger, East Trigger, West Trigger, Sticky Point, Active Lens, and Status Bar.

Section 5

PDACentric

PDACentric is an application programming environment designed to maximize utilization of the physical screen space of personal digital assistants (PDA) or handheld devices according to an embodiment of the invention. This software incorporates the Sticky Push architecture in a pen based computing device. FIG. 5-1 shows the present PDACentric application on a Compaq iPaq handheld device. This is an exemplary application programming environment according to an embodiment of the invention. This specific embodiment may also be executable on other computing devices utilizing a wide variety of different operating systems.

The motivation for the PDACentric application came from studying existing handheld device graphical user interfaces (GUI). Currently, the most popular handheld GUI's are the Palm PalmOS and Microsoft PocketPC. These GUIs are different in many aspects, and both provide the well-known WIMP (windows, icons, menus and pointing device) functionality for portable computer users. As discussed by Sondergaard, their GUIs are based on a restricted version of the WIMP GUI used in desktop devices. The WIMP GUI works well for desktop devices, but creates a usability challenge in handheld devices. The challenge is WIMP GUIs present content with controls used to interact with the content on the same visible layer. Presenting control components on the same layer as the content components wastes valuable pixels that could be used for content.

For example, FIG. 5-2 shows a Compaq iPaq running Microsoft's PocketPC operating system. The physical screen size for the device is 240×320 pixels. There are two control components on the top and bottom of the screen, including the title bar at the top and the task bar at the bottom. The title bar is roughly 29 pixels or 9 percent of the physical screen. The task bar is roughly 26 pixels or 8 percent of the screen. Together they account for 55 pixels or 17 percent of the total pixels on the screen. The problem is they are visible 100% percent of the time, but a user might only use them 5% of the total time, and they take up 17% of the total pixels on the physical screen. PDACentric was designed to utilize the pixels wasted by control components by separating the content and control components into distinct functional layers.

The present PDACentric application architecture has three functional layers: (1) the content layer, (2) the control layer, and (3) the logic layer. The content layer is a visible layer that displays content the user prefers to view and control with the Sticky Push. In FIG. 5-1, the content layer consists of the application with “Home” in the upper left hand corner and the icons on the right hand side. The control layer is a visible layer consisting of the Sticky Push. In FIG. 5-1, the Sticky Push is in the middle of the screen and contains all the components discussed in section 4. Finally, the logic layer is an invisible layer handling the content and control layer logic and their communication.

The layout of this section begins with a discussion of the difference between control and content. Then each of the three PDACentric functional layers is discussed.

5.1 Content vs. Control

PDACentric separates content and control GUI components into distinct visible layers. This separation permits content to be maximized to the physical screen of the handheld device. Content GUI components refer to information or data a user desires to read, display or control. Control GUI components are the components the user can interact with to edit, manipulate, or “exercise authoritative or dominating influence over” the content components. An example of the difference between content and control GUI components could be understood with a web browser.

In a web browser, the content a user wishes to display, read and manipulate is the HMTL page requested from the server. The user can display pictures, read text and potentially interact with the web page. To control—or “exercise authoritative influence over”—the webpage, the user must select options from the tool bar or use a mouse pointer to click or interact with webpage objects like hyperlinks. Understanding this differentiation is important for comprehension of the distinct separation of content from control components.

5.2 Functional Layers

The PDACentric architecture has three functional layers: the content layer, the control layer, and the logic layer. The intent of separating the control layer from content layer was to maximize the limited physical screen real estate of the handheld device. The content layer consists of the applications and content users prefer to view. The control layer consists of all control the user is able to perform over the content via the Sticky Push. Finally, the logic layer handles the communication between the content and control layers. FIG. 5-3 shows the separation of the three functional layers.

5.2.1 Content Layer

The content layer consists of applications or information the user prefers to read, display or manipulate. PDACentric content is displayable up to the size of the usable physical limitations of the handheld device. For instance, many handheld devices have screen resolutions of 240×320 pixels. A user would be able to read text in the entire usable 240×320 pixel area, uninhibited by control components. To control content in the present PDACentric application, the user must use the Sticky Push as input in the control layer. Shown in FIG. 5-1, the “Home” application presented on the Compaq iPaq screen is the active application in the content layer.

5.2.2 Control Layer

The control layer floats above the content layer as shown in FIG. 5-3. The Sticky Push resides in the control layer. In this layer, the Sticky Push provides a graphical interface for the user to interact with content in the layer below. This allows the Sticky Push to be moved to any location within the physical limitations of the device. The Sticky Push is able to perform all tasks mentioned in the previous section. These tasks include opening triggers (North and West Triggers), retracting the Control Lens, selecting content with the Sticky Point and moving around the physical screen area. These tasks are shown in FIG. 5-4.

In FIG. 5-4 (A), the Sticky Push has the North and West Triggers open. Each trigger in the present PDA centric architecture has a specific role. The North Trigger is responsible for displaying icons that are able to change the properties of the Sticky Push. For example, the left icon in the North Trigger will be a preferences icon. If this icon is selected, it will present the user options to change the appearance—or attributes—of the Sticky Push. The North Trigger icon functionality is not implemented and is discussed as a future direction in Section 7. The West Trigger is responsible for displaying icons corresponding to applications the user is able to control. For example, the top icon on the West Trigger is the “Home” icon. If the user selects this icon, the “Home” application will be placed as the active application in the content layer.

FIG. 5-4 (B) shows the Sticky Push Control Lens to be invisible. The only Sticky Push component visible is the Push Pad. Retracting the Control Lens allows the user to view more content on the content layer uninhibited by the Control Lens.

Shown in FIG. 5-4 (C) is the Sticky Point selecting an icon on the content layer and the Status Bar is guiding the user by indicating the active icon's name. Finally, FIG. 5-4 (D) shows the Control Lens with a new Active Lens loaded.

5.2.3 Logic Layer

The logic layer is an invisible communication and logic intermediary between the control and content layers. This layer is divided into three components: (1) Application Logic, (2) Lens Logic, and (3) Push Engine. The Application Logic consists of all logic necessary to communicate, display and control content in the Content Layer. The Lens Logic consists of the logic necessary for the Control Lens of the Sticky Push and its communication with the Content Layer. Finally, the Push Engine consists of all the logic necessary to move and resize the Sticky Push.

FIG. 5-5 shows the communication between each component in the logic layer. A user enters input with a pen into the Sticky Push in the Control Layer. Once the user enters input, the Logic Layer determines what type of input was entered. If the user is moving the Sticky Push via the Sticky Pad, then the Push Engine handles the logic of relocating all the Sticky Push components on the screen. If the user is trying to control content in an application, the Lens Logic and Application Logic communicate based on input from the user.

The Application Logic manages all applications controllable by the Sticky Push. It knows what application is currently being controlled and what applications the user is able to select. Also, the Application Logic knows the icon over which the Sticky Point lies. If the Control Lens needs to load an active lens based on the active icon, it requests the lens from the Application Logic.

The Lens Logic knows whether the Control Lens should be retracted or expanded based on user input. It knows if the Sticky Point is over an icon with the ability to load a new Active Lens. Finally, it knows if the user moved the pen into the Right or Left Sticky Pad. The Right and Left Sticky Pads can have different functionality as show in FIGS. 4-10 and 4-11.

The Push Engine logic component is responsible for moving and resizing all Sticky Push components. Moving the Sticky Push was shown in FIG. 4-4. When the user places the pen in the Push Pad and moves the Sticky Push, every component must reposition itself to the new location. The Push Engine provides the logic to allow these components to reposition. Also, if a user decides to load a new Active Lens or open a Trigger, the Push engine must resize all the necessary components. Two examples of resizing the Sticky Push can be seen in FIGS. 5-4 (A) and 5-4 (D). In FIG. 5-4 (A), the Sticky Push has the North and West Triggers open. When the user selected these triggers to open, all surrounding components resized themselves to the height or width of the open triggers. Finally, in FIG. 5-4 (D), the Sticky Push has an opaque Active Lens loaded. When it was loaded, the Push Engine told all the surrounding components how to resize themselves to match the new opaque Active Lens dimensions.

5.3 PDACentric Summary

PDACentric is provided as an exemplary embodiment according to the present invention. The PDACentric application programming environment is designed to maximize content on the limited screen sizes of personal digital assistants. To accomplish this task three functional layers were utilized: the content layer, the control layer, and the logic layer. The content layer is a visible layer consisting of components the user desires to view and control. The control layer is a visible layer consisting of the Sticky Push. Finally, the logic layer is an invisible layer providing the logic for the content and control layers and their communication. This specific embodiment of the invention may be operable on other device types utilizing various operating systems.

Section 6

This section includes the results of a study performed to evaluate different features of the present invention in a handheld computing embodiment. The comments contained in this section and any references made to comments contained herein, or Appendix B below, are not necessarily the comments, statements, or admissions of the inventor and are not intended to be imputed upon the inventor.

Sticky Push Evaluation

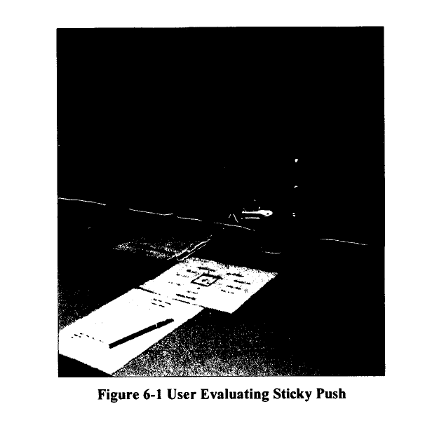

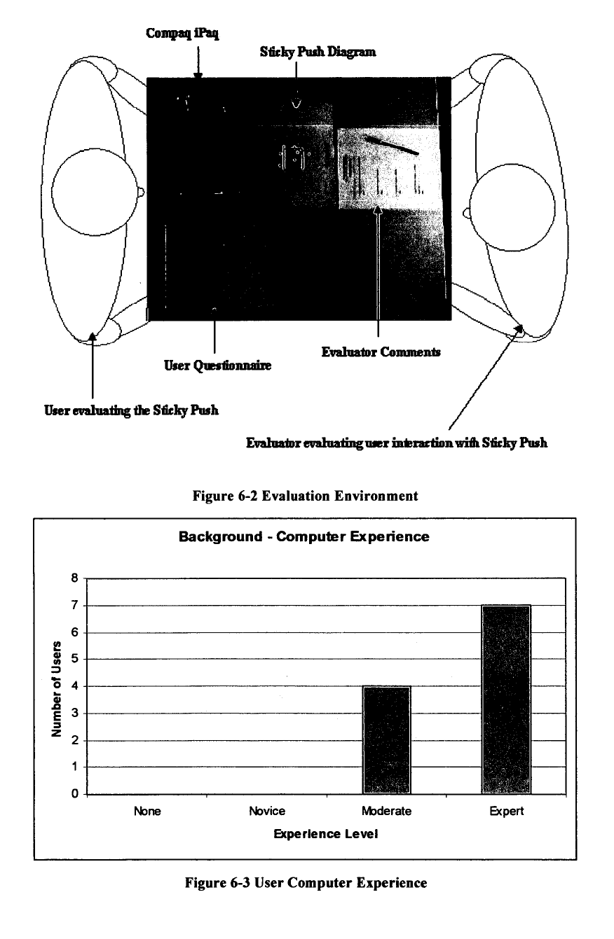

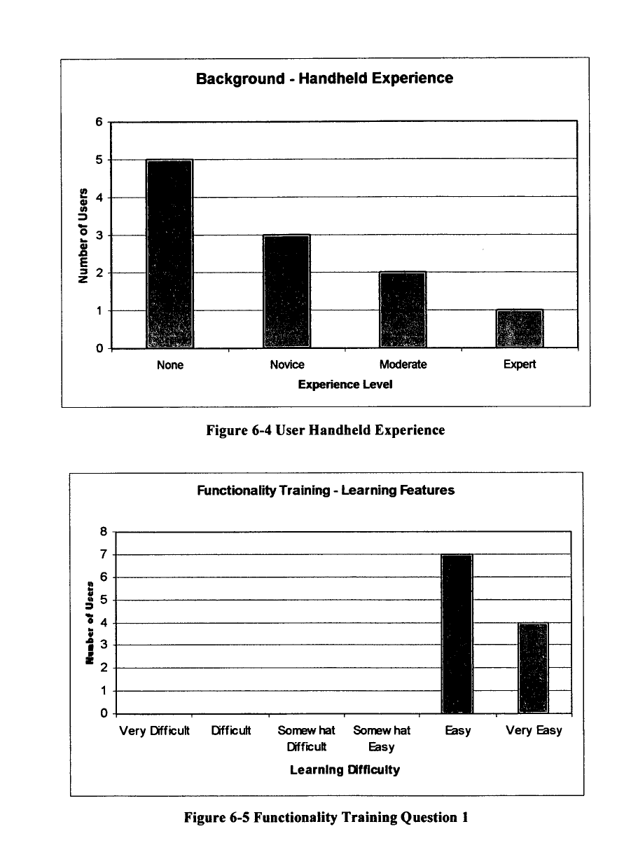

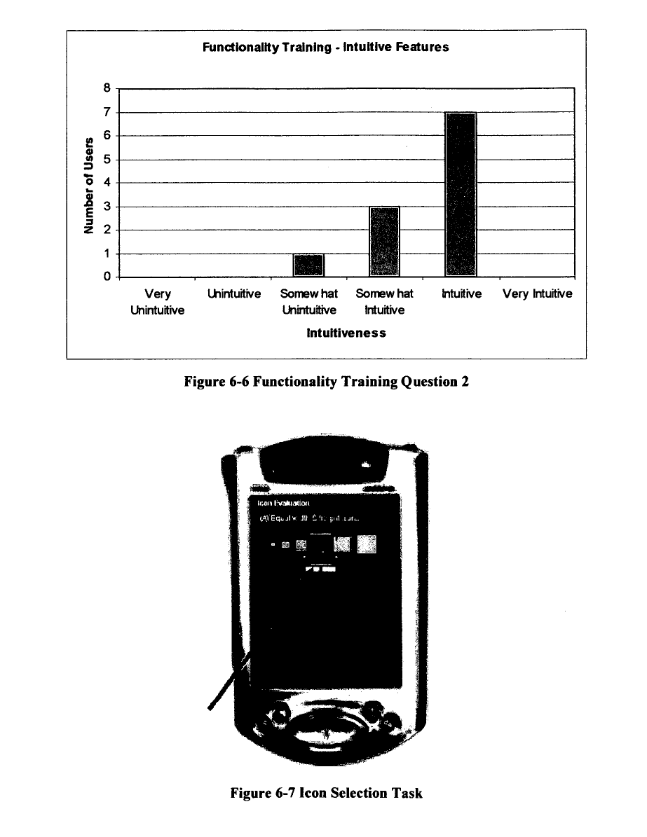

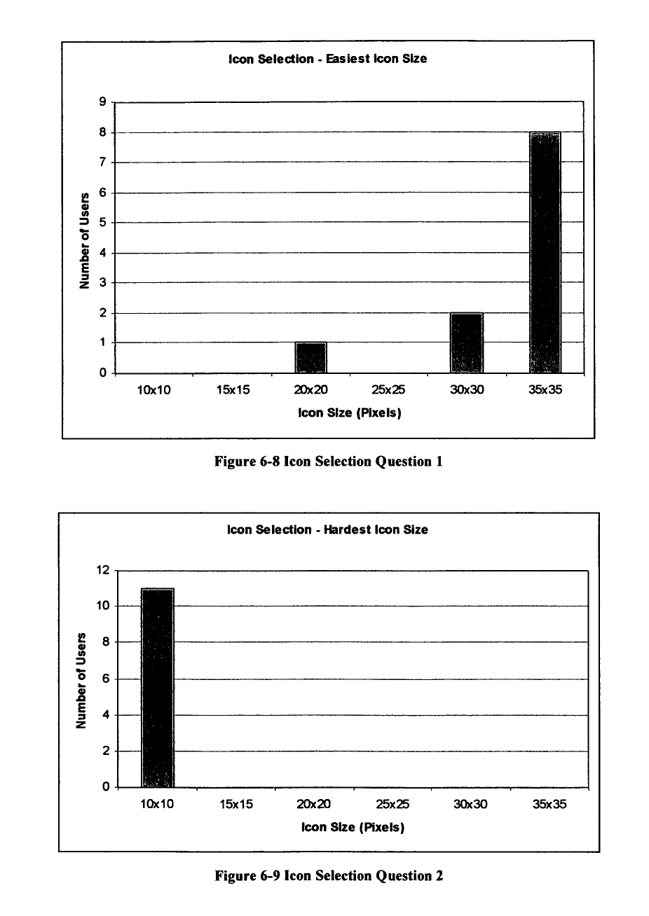

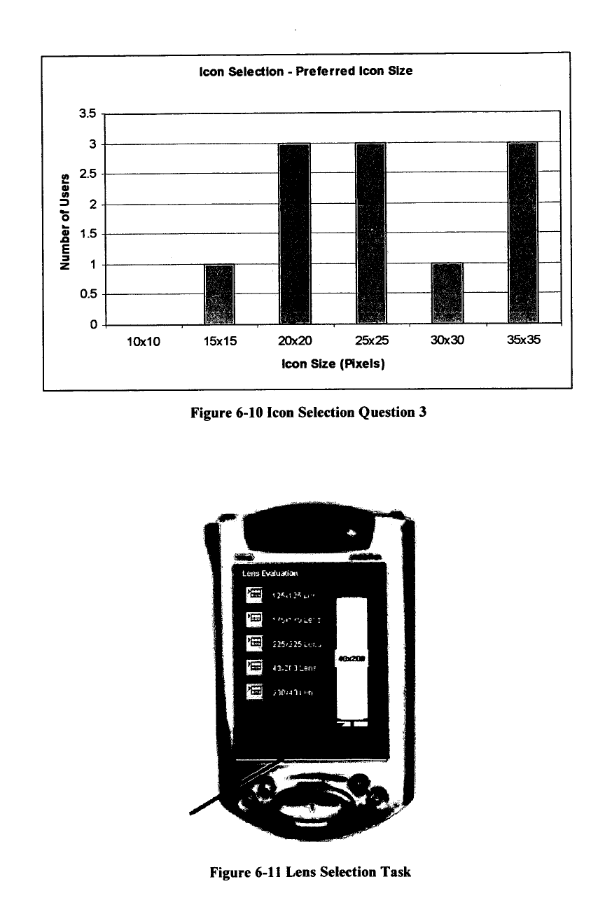

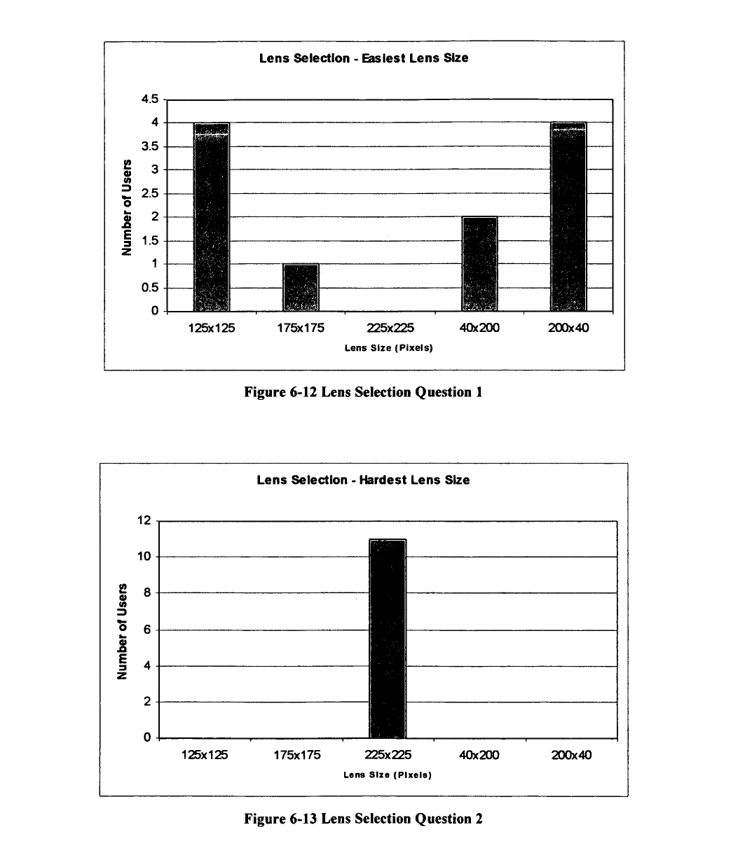

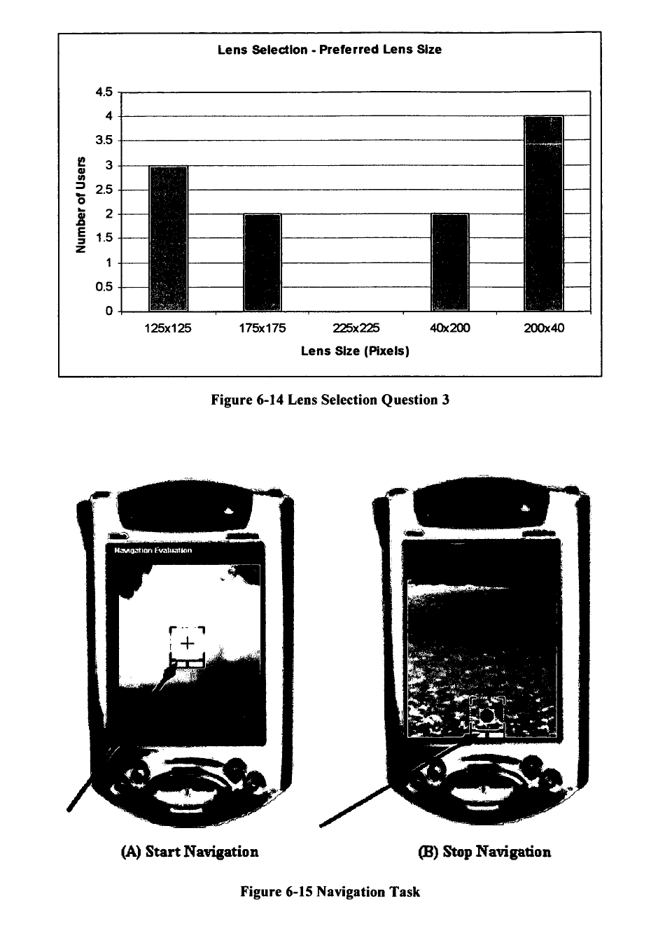

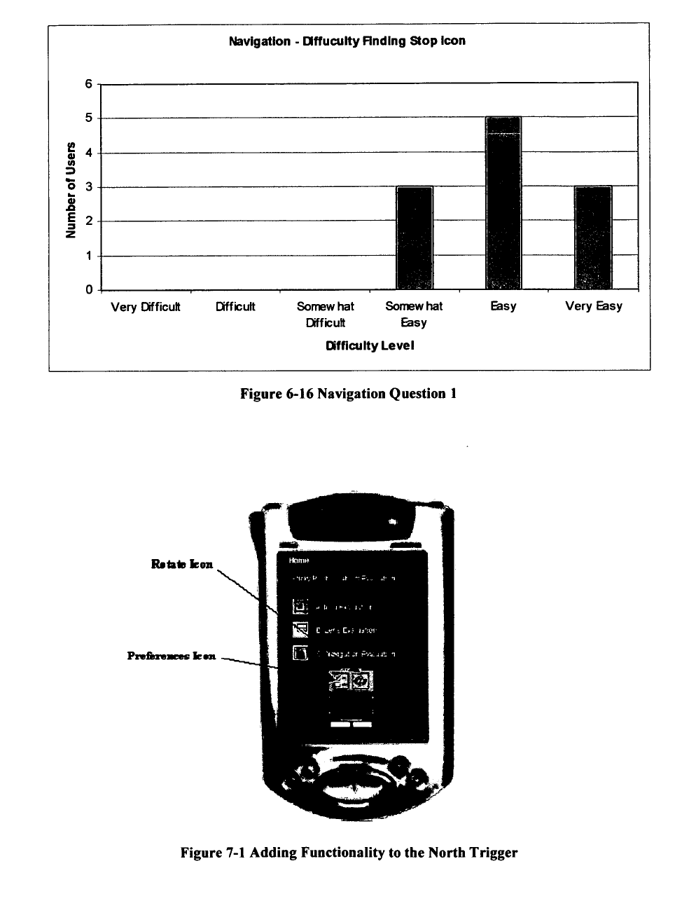

Evaluating the Sticky Push consisted of conducting a formal evaluation with eleven students at the University of Kansas. Each student was trained on the functionality of the Sticky Push. Once training was completed each student was asked to perform the same set of tasks. The set of tasks were: icon selection, lens selection, and navigation. Once a task was completed, each student answered questions pertaining to the respective task and commented on the functionality of the task. Also, while the students performed their evaluation of the Sticky Push, an evaluator was evaluating and commenting on the students interactions with the Sticky Push. A student evaluating the Sticky Push is shown in FIG. 6-1.

The layout of this chapter consists of discussing (6.1) the evaluation environment, (6.2) the users, (6.3) and the functionality training. Then each of the three tasks the user was asked to perform with the Sticky Push is discussed: (6.4) icon selection, (6.5) lens selection, and (6.6) navigation. Finally, when the tasks were completed, users were asked several (6.7) closing questions. Refer to Appendix B for the evaluation environment questionnaires, visual aids, raw data associated with user answers to questions, and comments from the users and the evaluator.

6.1 Evaluation Environment

Users were formally evaluated in a limited access laboratory at the University of Kansas. As shown in FIG. 6-2, two participants sat across a table from each other during the evaluation. The participant on the left side of the table is the user evaluating the Sticky Push. The participant on the right side of the table is the evaluator evaluating user interactions with the Sticky Push. Between the two participants are questionnaires, a Sticky Push visual aid, a Compaq iPaq, and several pointing and writing utensils. The two questionnaires were the user questionnaire and the evaluator comments sheet.

6.2 Users

Eleven students at the University of Kansas evaluated the Sticky Push. The majority of these students were pursing a Masters in Computer Science. Thus, most of the students have significant experience with computers labeling their experience as either moderate or expert, as shown in FIG. 6-3.

Shown in FIG. 6-4 is the users background experience with using handheld devices. Most students had limited experience with handheld devices. The majority of the students either classified themselves as having no—or none—handheld experience or thought of themselves as novice users.

6.3 Functionality Training

Before asking the users to perform specific tasks to evaluate the Sticky Push, they were trained on the functionality of the Sticky Push. This functionality included showing the user how to move the Sticky Push (refer to chapter 4), how to retract the Lens Retractor, how to goal-cross the West Trigger, how to select icons and how to load an Active Lens. The functionality training lasted between 5 and 10 minutes.

Once the users completed the functionality training, they were asked to answer two questions and write comments if desired. The two questions were:
1. Are the Sticky Push features easy to learn?
2. Are the Sticky Push features intuitive to learn?

FIGS. 6-5 and 6-6 show histograms associated with the cumulative answers from the users to each question, respectively. Most of the users thought the Sticky Push functionality was easy or very easy to learn. Also, the intuitiveness of the Sticky Push ranged form somewhat unintuitive to intuitive. The users thought the Sticky Push was easy to learn, however, they didn't think the functionality was easily understood if not specifically trained by the evaluator. After the users were trained, each was asked to perform the first Sticky Push task of icon selection.

6.4 Icon Selection

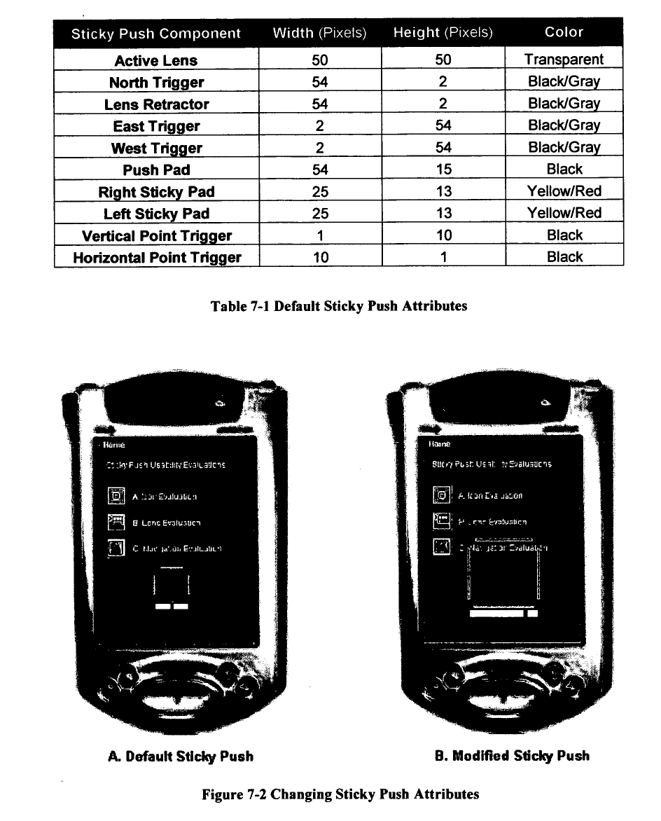

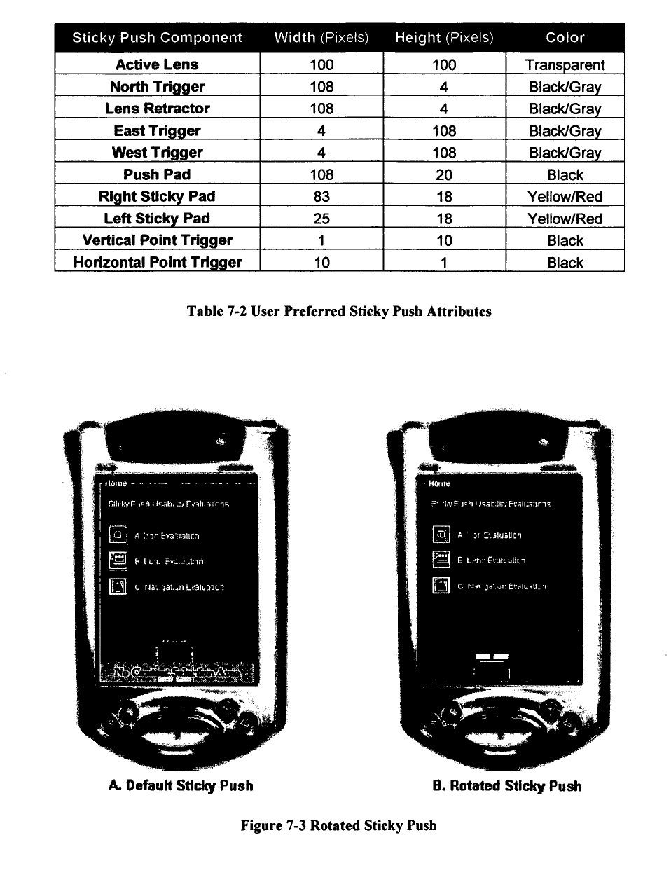

The first task the users were asked to perform was that of icon selection with the Sticky Push. The users were asked to move the Sticky Push over each of six icons of variable sizes. When the Sticky Point of the Sticky Push was within the boundaries of each icon, the Status Bar displayed the pixel size of the icon, as shown in FIG. 6-7.

Once the user moved the Sticky Push over each of the six icons, the user was asked to answer three questions:
1. What is the easiest icon size to select with the Sticky Push?
2. What is the most difficult icon to select with the Sticky Push?
3. What is your preferred icon size to select with the Sticky Push?

The cumulative results of the three questions can be seen in the histograms in FIGS. 6-8, 6-9 and 6-10.

The results of the icon selection questions were as expected. Users thought the easiest icon size to select was the largest (35×35 pixels) and the hardest was the smallest (10×10). There were several groups of users who preferred different sizes as their preferred icon size to select, as shown in FIG. 6-10. Some preferred the larger icons to select because they have more area, and thus it takes less movement of the Sticky Push to find the larger icon. Others thought the smaller icon sizes weren't necessarily harder to select, they just required more precision when selecting them. Finally, the performance of the Sticky Push caused the Sticky Push to be slightly delayed when moving it. Thus, the Sticky Point was slightly delayed, where this delay was thought to make selection of the smaller icons harder. Once the icon selection task was completed, the users were asked to perform a lens selection task.

6.5 Lens Selection

The second task the users were asked to perform was that of selecting icons that loaded Active Lenses into the Control Lens of the Sticky Push. The users were asked to move the Sticky Push over each of five icons. When the Sticky Point of the Sticky Push was within the boundaries of each icon, and the user lifted the pen from the Push Pad, the Active Lens associated with the icon was loaded into the Control Lens.

Once the new Active Lens was loaded, the users were asked to move the Sticky Push to the center of the screen, as shown in FIG. 6-11. This task was performed for each icon, where each icon had a different pixel sized Active Lens to be loaded into the Control Lens. Once the user moved the Sticky Push over each of the five icons and loaded each Active Lens, the user was asked to answer three questions:
1. What is the easiest Active Lens size to select and move with the Sticky Push?
2. What is the most difficult Active Lens size to select and move with the Sticky Push?
3. What is your preferred Active Lens size to select and move with the Sticky Push?

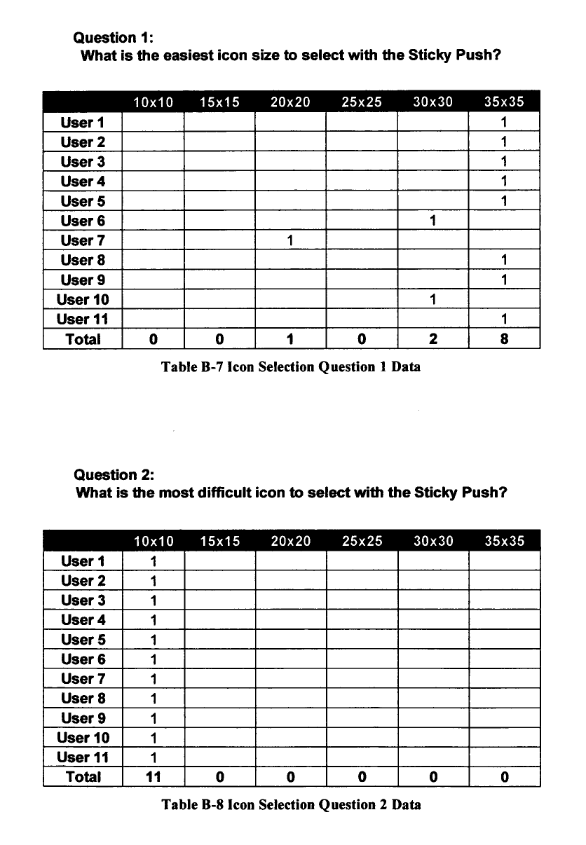

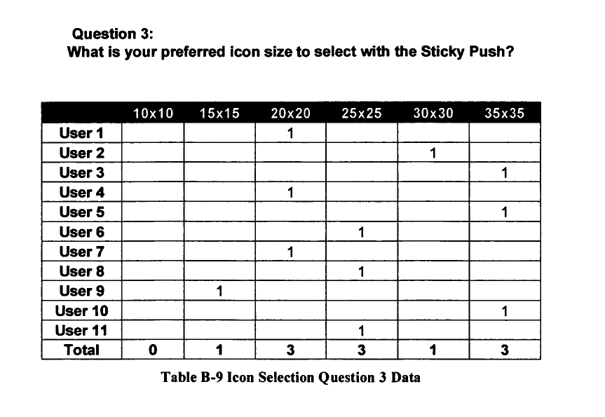

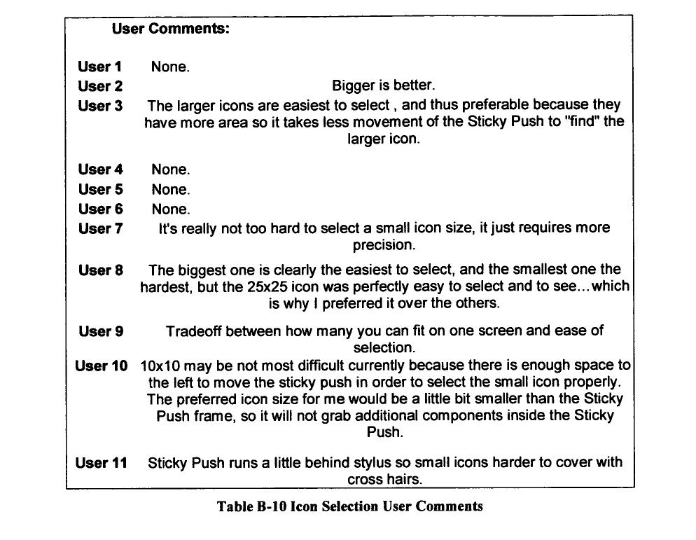

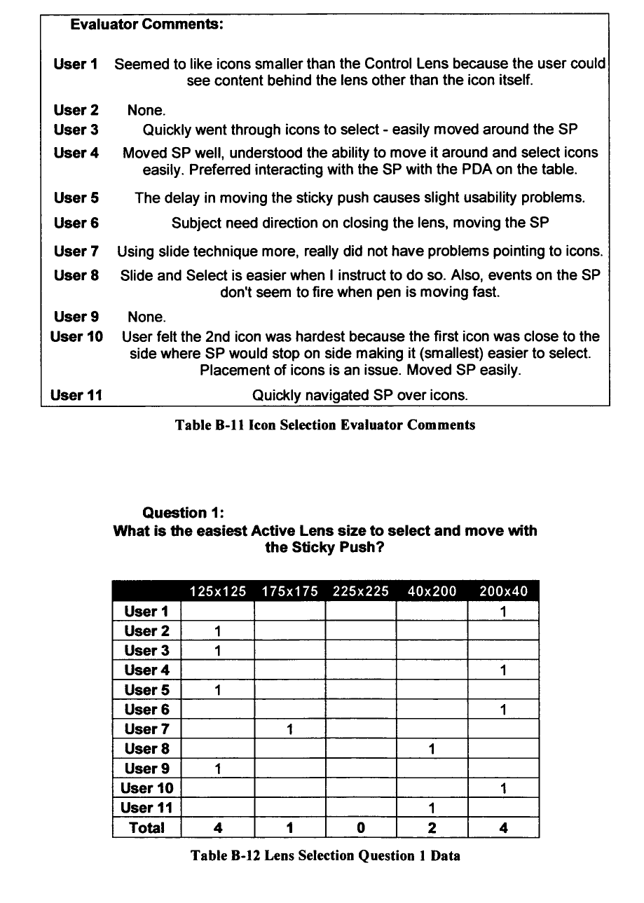

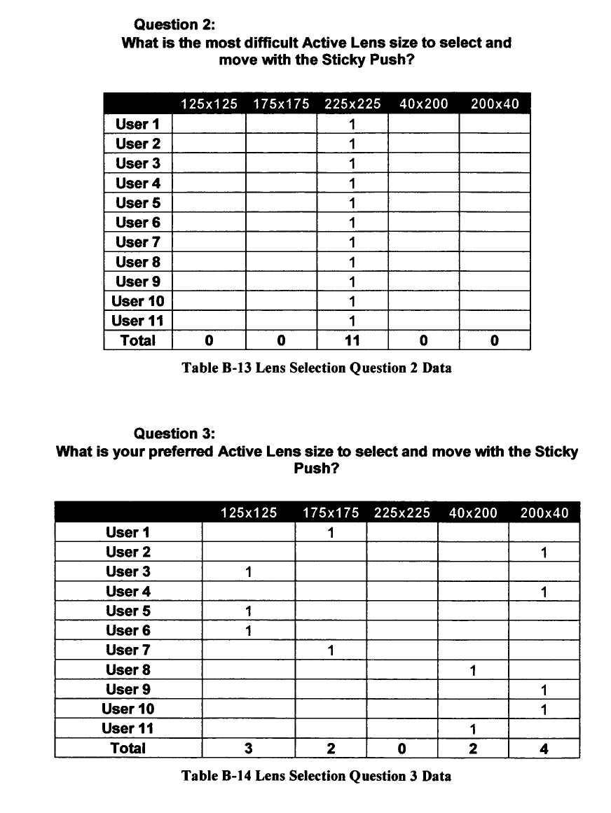

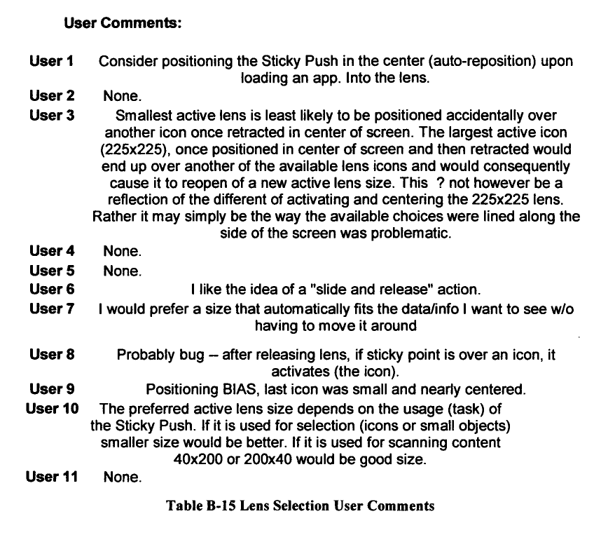

The cumulative results of the three questions can be seen in the histograms in FIGS. 6-12, 6-13 and 6-14.

The results of the lens selection questions showed a variation in user preferences as to the easiest and preferred lens sizes to load and move. As shown in FIG. 6-12, several of the users preferred the smaller equal sized Active Lens (125×125). Also, several users preferred the variable sized Active Lens that has wider than high—or 200×40 pixels. All users believed the largest Active Lens size (225×225 pixels) was the hardest to load and move.

Several of the users thought it would be nice to have the Sticky Push reposition itself into the center of the screen once an Active Lens was loaded. They believed moving the Active Lens to the center of the screen manually wasn't necessary and that usability would improve if the task was automated. Also, users thought that different Active Lens sizes would be preferred for different tasks. For example, if someone was scanning a list horizontally with a magnifying glass, the 200×40 Active Lens would be preferred. This is because the width takes up the entire width of the screen. Also, it was thought that the placement of the icons might have biased user preferences on loaded Active Lenses. Finally, all the users were able to distinguish the functionality of the Right and Left Sticky Pads easily (refer to chapter 4) and remember goal-crossing techniques when they were necessary. Once the icon selection task was completed, the users were asked to perform a navigation task.

6.6 Navigation

The third task the users were asked to perform was that of moving—or navigating—the Sticky Push around a screen to find an icon with a stop sign pictured on it.

The icon with the stop sign was located on an image that was larger than the physical screen size of the handheld device. The handheld device screen was 240×320 pixels and the image size was 800×600 pixels. The Sticky Push has built in functionality to know if the content the user is viewing is larger then the physical screen size, then the Sticky Push is able to scroll the image up, down, right and left (refer to chapter 4).

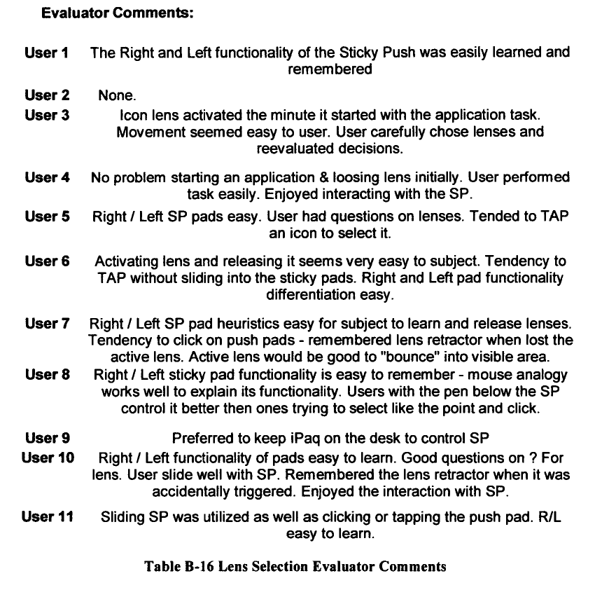

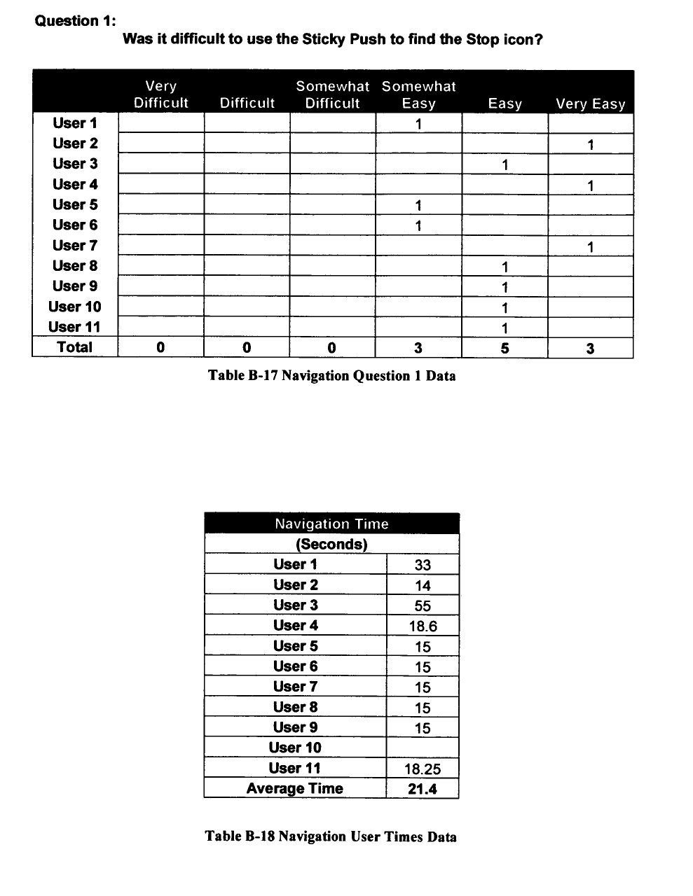

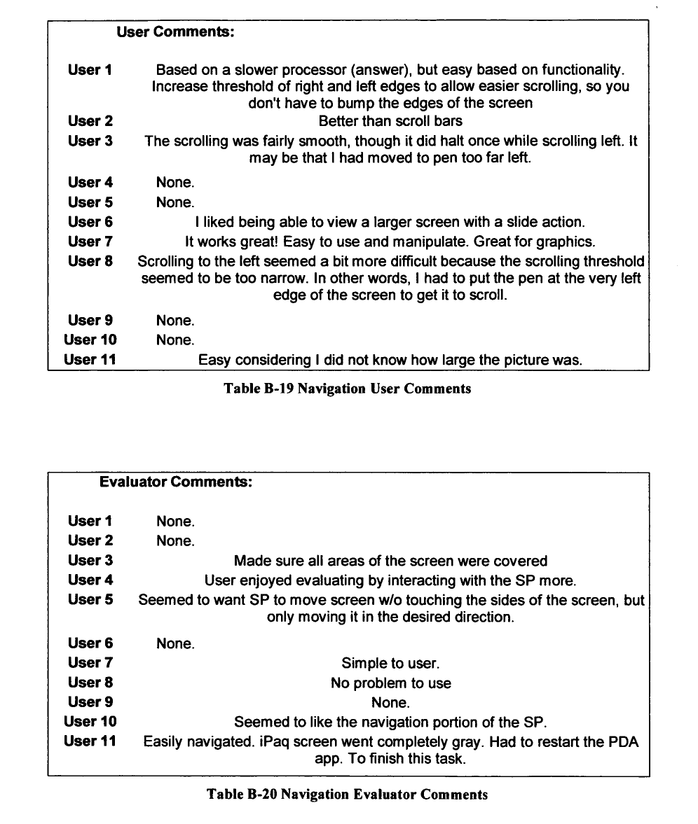

Shown in FIG. 6-15 is the Sticky Push at the start of the navigation task (A) and at the end of the navigation task (B). Users were timed while they moved the Sticky Push around the screen to locate the stop icon. The average time for the users was 21 seconds (refer to table B-18). Once the user found the stop icon, the user was asked to answer one question:
1. Was it difficult to use the Sticky Push to find the Stop icon?

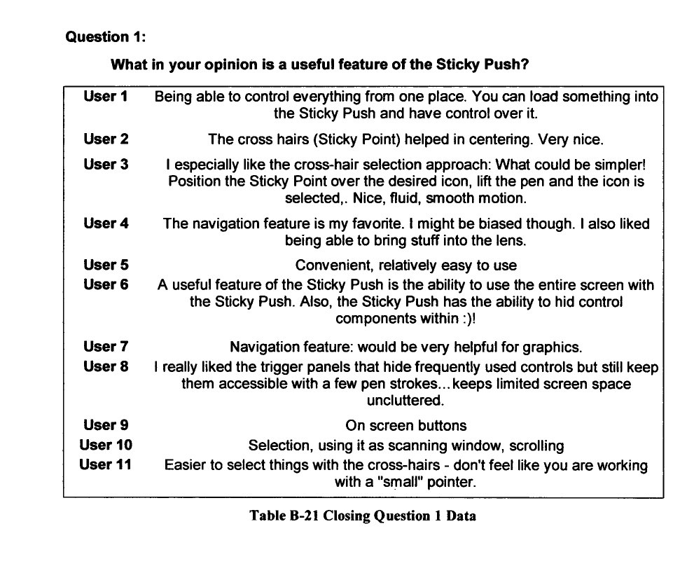

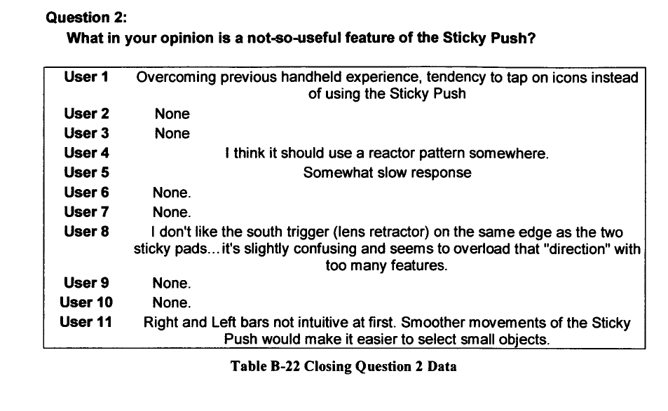

As shown in FIG. 6-16, the users thought that navigating the Sticky Push was somewhat easy to very easy. Most of the users believed the navigation feature of the Sticky Push was an improvement over traditional scroll-bars in the traditional WIMP GUI. Several of the users thought the performance of moving the Sticky Push was sluggish, which they believed was based on the handheld hardware.

6.7 Closing Questions

Once the navigation task was completed, the users were asked two closing questions:
1. What in your opinion is a useful feature of the Sticky Push?
2. What in your opinion is a not-so-useful feature of the Sticky Push?

Users thought there were several useful features of the Sticky Push including the Sticky Point (cross-hairs), the ability to load an Active Lens and move it around the screen, navigating the Sticky Push, and the Trigger Panels. Only one user thought the Lens Retractor was a not-so-useful feature of the Sticky Push. It was believed having the Lens Retractor on the same “edge” as the Push Pad seemed to overload that “direction” with too many features. No other feature was believed to be not-so-useful.

6.8 Sticky Push Evaluation Summary

A formal evaluation was conducted to evaluate the functionality of the Sticky Push. Eleven students participated in the evaluation from the University of Kansas. Each student was trained on the features of the Sticky Push then asked to perform three tasks. The tasks were: (1) icon selection, (2) lens selection, and (3) navigation. Once a task was completed, each student answered questions pertaining to the respective task and commented on the functionality of the task. While the students performed their evaluation of the Sticky Push, an evaluator was evaluating and commenting on the students interactions with the Sticky Push.

Section 7

Alternate Embodiments

During implementation and evaluation of the Sticky Push and PDACentric, four future directions became evident. First, the Sticky Push should be more customizable allowing the user to set preferences. Second, the user should be allowed to rotate the Sticky Push. These first two future directions should be added as functionality in the North Trigger. Third, the performance of the Sticky Push should be enhanced. Forth, the Sticky Push should be evaluated in a desktop computing environment.

The remainder of this section is divided into 3 sections: (1) North Trigger Functionality, (2) Performance, and (3) Desktop Evaluation.

7.1 North Trigger Functionality

Additional functionality of the present invention includes: (1) allowing the user to set Sticky Push preferences and (2) allowing the user to rotate the Sticky Push. As shown in FIG. 7-1, these features are shown in the North Trigger of the Sticky Push with icons for the user to select. The icons shown are: Preferences, and Rotate. A user may goal-cross though the respective icon, and the icon would present its functionality to the user. The remainder of this section is divided into two sections correlating with the two icons: (1) Preferences, and (2) Rotate.

7.1.1 Preferences

Sticky Push usability improves by allowing the user to change its attributes. The default set of Sticky Push component attributes in one embodiment can be seen in Table 7-1. This table lists each component with its width, height and color. FIG. 7-2 (A) shows a picture of a Sticky Push embodiment with the default attributes in the PDACentric application programming environment.

According to this embodiment, users have the ability to change the attributes of the Sticky Push to their individual preferences. For example, a user may prefer the set of Sticky Push attributes shown in Table 7-2. In this table, several Sticky Push components doubled in pixel size. Also, the Left Sticky Pad takes up 80% of the Push Pad and the Right Sticky Pad takes up 20%. FIG. 7-2 (B) shows a picture of the Sticky Push with the new set of attributes in the PDACentric application programming environment.

Allowing users to decide on their preferred Sticky Push attribute benefits many users. For example, someone with bad eyesight might not be able to see Sticky Push components at their default sizes. The user may increase the size of these components to sizes easier to see. This provides the user with a more usable interactive pointing guide.

7.1.2 Rotate

The second feature that improves usability is allowing the user to rotate the Sticky Push. The default position of the Sticky Push is with the Push Pad as the lowest component and the North Trigger as the highest component. As shown in FIG. 7-3(A), the default Sticky Push position in this exemplary embodiment does not allow the user to select content on the bottom 20-30 pixels of the screen because the Sticky Point cannot be navigated to that area. It is therefore better to allow the Sticky Push to rotate so the user may navigate and select content on the entire screen. As shown in FIG. 7-3(B), the Sticky Push is rotated and the Sticky Point is able to point to content in the screen area not selectable by the default Sticky Push.

7.2 Performance

The exemplary PDACentric application programming environment is implemented using the Java programming language (other languages can be used and have been contemplated to create an IPG according to the present invention). Evaluations for the implementation were performed on a Compaq iPaq H3600. When performing the evaluations, the Sticky Push had a slight delay when moving it around the screen and when selecting a Trigger to open or close. This delay when interacting with the Sticky Push could be caused by several things including the iPaq processor speed, Java garbage collector, or a logic error in a component in the PDACentric application programming environment. Steps to eliminate this interactive delay include the following:

To accomplish this task, two approaches may be taken: port and test PDACentric on a handheld with a faster processor, or implement PDACentric in an alternative programming language. Obviously, the easiest approach is to port PDACentric to a handheld with a faster processor. The second approach is more time consuming, but the PDACentric architecture discussed in Appendix A could be utilized and implemented with an object-oriented programming language like C++.

7.3 Desktop Evaluation

Using Sticky Push and PDACentric improve usability on other computing devices such as a desktop computer, a laptop/notebook computer, a Tablet computer, a household appliance with a smart controller and graphical user interface, or any other type of graphical interface on a computing device or device or machine controller utilizing a graphical user interface. This task is accomplished in several ways. One way in particular is to use the existing Java PDACentric application programming environment modifying the Sticky Push to listen to input from a mouse and mouse pointer or other input device as the implementation may require. This is accomplished by modifying the inner KPenListener class in the KPushEngine class. Once this is completed, the same evaluation questions and programs used for evaluations on the handheld device may be used for the specific implementation device.

7.4 Alerntate Embodiment Summary

Alternate embodiments of the present invention include implementation on laptop/notebook computers, desktop computers, Tablet PCs, and any other device with a graphical user interface utilizing any of a wide variety of operating systems including a Microsoft Windows family operating system, OS/2 Warp, Apple OS/X, Lindows, Linux, and Unix. The present invention includes three further specific alternate embodiments. First, the Sticky Push may be more customizable allowing the user to set its preferences. Second, the user may be allowed to rotate the Sticky Push. Both of these features could be added in the North Trigger of the Sticky Push with icons for the user to select. Third, the Sticky Push performance may be improved utilizing various methods.

Section 8

Conclusions

Today, a mainstream way for users to interact with desktop computers is with the graphical user interface (GUI) and mouse. Because of the success of this traditional GUI on desktop computers, it was implemented in smaller personal digital assistants (PDA) or handheld devices. A problem is that this traditional GUI works well on desktop computers with large screens, but takes up valuable space on smaller screen devices, such as PDAs.

An interactive pointing guide (IPG) is a software graphical component, which may be implemented in computing devices to improve usability. The present interactive pointing guide has three characteristics: (1) it is interactive, (2) it is movable, and (3) it guides.

The present Sticky Push embodiment is an interactive pointing guide (IPG) used to maximize utilization of screen space on handheld devices. The Sticky Push is made up of two main components: the control lens, and the push pad. To implement and evaluate the functionality of the Sticky Push an application called PDACentric was developed.

PDACentric is an application programming environment according to an embodiment the present invention designed to maximize utilization of the physical screen space of personal digital assistants (PDA). This software incorporates the Sticky Push architecture in a pen based computing device. The present PDACentric application architecture has three functional layers: (1) the content layer, (2) the control layer, and (3) the logic layer. The content layer is a visible layer that displays content the user prefers to view and control with the Sticky Push. The control layer is a visible layer consisting of the Sticky Push. Finally, the logic layer is an invisible layer handling the content and control layer logic and their communication.

In summary, the present Sticky Push has much potential in enhancing usability in handheld, tablet, and desktop computers. Futher, the present invention has the same potential in other computing devices such as in smart controllers having a graphical user interface on household appliances, manufacturing machines, automobile driver and passenger controls, and other devices utilizing a graphical user interface. It is an exciting, novel interactive technique that has potential to change the way people interact with computing devices.

### REFERENCES

[1] Accot, J., Zhai, Shumin. More than dotting the I's—Foundations for crossing-based interfaces. CHI, Vol. 4, Issue No. 1, Apr. 20-25, 2002, pp. 73-80.
[2] Apple, http://www.apple.com
[3] Benderson, B., Czerqinski, M., Robertson, G., A Fisheye Calendar Interface for PDAs: Providing Overviews for Small Displays. HCIL Tech Report #HCIL-2002-09, May 2002.
[4] Benderson, B. Meyer, J, Good, L., Jazz: An Extensible Zoomable User Interface Graphics Toolkit in Java. UIST 2000, pp. 171-180.
[5] Benderson, B., Hollan, J., Pad++: A Zooming Graphical Interface for Exploring Alternate Interface Physics. UIST, 1994, pp. 17-26.
[6] Brewster, S., Overcoming the Lack of Screen Space on Mobile Computers. London, Springer-Verlag London Ltd, Personal and Ubiquitous Computing, 2002, 6:188-205.
[7] Brier, E., Stone, M., Pier, K., Buxton, W., Derose, T., Toolglass and Magic Lenses: The See-through Interface. SIGGRAPH Conference Proceedings, 1993, pp. 73-80.
[8] Compaq, http://www.compaq.com
[9] Furnas, G., The FISHEYE View: A New Look at Structured Files. Reprinted in: Readings in Information Visualization. Using Vision to Think, edited by Card, Stuart, Mackinlay, Jock, and Shneiderman, Ben. Morgan Kaufmann Publishers, Inc. 1999, http://www.si.umich.edu/˜furnas/Papers/FisheyeOriginalTM.pdf
[10] Furnas, G., The Fisheye Calendar System. Bellcore, Morristown, N.J., 1991. http://www.si.umich.edu/˜furnas/Papers/FisheyeCalendarTM.pdf
[11] Harrison, B., Ishii, H., Vicente, K., Buxton, W., Transparent Layered User Interfaces: An Evaluation of a Display Design to Enhance Focused and Divided Attention. CHI Proceedings, 1995.
[12] Hopkins, D., The design and implementation of pie menus. In D. Dobb's journal 1, 1991, 6:12 pp. 16-26.
[13] Java, http://www.javasoft.com
[14] Kamba, T., Elson, S., Harpold, T., Stamper, T., Sukaviriya, P. Using Small Screen Space More Efficiently. CHI, Apr. 13-18, 1996, pp. 383-390.
[15] Kurtenbach, G., Buxton, W., User Learning and Performance with Marking Menus. CHI Proceedings, 1994, pp. 258-64.
[16] Microsoft, www.microsoft.com
[17] Palm, http://www.palm.com
[18] Palm Source, http://www.palmos.com
[19] Palo Alto Research Center, http://www.parc.xerox.com/company/history
[20] Perlin, K. Fox, D., Pad: An Alternative Approach to the Computer Interface. SIGGRAPH '93, New York, N.Y., ACM Press, pp. 57-64.
[21] Pocket PC, http://www.pocketpc.com
[22] Ren, X., Improving Selection Performance on Pen-Based Systems: A Study of Pen-Based Interaction for Selection Tasks. ACM Transactions on Computer-Human Interfaces, Vol. 7, No. 3, September 2000, pp. 384-416.
[23] Sondergaard, A., A Discussion of Interaction Techniques for PDAs. Advanced Interaction Techniques, Multimedieuddannelsen, Aarhus Universitet, 15/6-2000, http://www.daimi.au.dk/˜astrid/pda/aiteksamen.doc
[24] Tambe, R., Zooming User Intefaces for Hand-Held Devices. http://www.eecs.utoledo.edu/rashmi/research/zooming%20user%20interfaces%20p aper.pdf
[25] Tapia, M., Kurtenbach, G., Some Design Refinements and Principles on the Appearance and Behavior of Marking Menus. UIST, November 1995 Pittsburg Pa., USA, pp. 189-19.
[26] The American Heritage Dictionary of the English Language, Fourth Edition. Houghton Mifflin Company, 2000.
[27] Walrath, K, Campione, M., The JFC Swing Tutorial: A Guide to Constructing GUI'S. Reading, Massachusets: Addison-Wesley, 1999.
   Appendix A
   PDACentric Embodiment: A Java Implementation

The present PDACentric application embodiment of the invention was implemented using the Java programming language. This appendix and the description herein are provided as an example of an implementation of the present invention. Other programming languages may be used and alternative coding techniques, methods, data structures, and coding constructs would be evident to one of skill in the art of computer programming. This application has many components derived from a class called KComponent. As shown in FIG. A-1, the software implementation was split into three functional pieces: (1) content, (2) control, and (3) logic. The three functional pieces correspond to the functional layers described in Section 5.

The layout of this appendix begins with a discussion of the base class KComponent. Then each of the three PDACentric functional pieces are discussed.

A.1 KComponent

KComponent is derived from a Java Swing component called a JPanel. The KComponent class has several methods enabling derived classes to easily resize themselves. Two abstract methods specifying required functionality for derived classes are isPenEntered( ) and resizeComponents( ).

Method isPenEntered( ) is called from the logic and content layers to determine if the Sticky Point has entered the graphical boundaries of a class derived from KComponent. For example, each KIcon in the content layer needs to know if the Sticky Point has entered its boundaries. If the Sticky Point has entered its boundaries, KIcon will make itself active and tell the Application Logic class it is active.

Method resizeComponents( ) is called from the KPushEngine class when the Sticky Push is being moved or resized. KPushEngine will call this method on every derived KComponent class when the Sticky Push resizes.

A.2 Control

The control component in the PDACentric architecture consists of the Sticky Push components. As shown in FIG. A-1, five classes are derived from KComponent: KControlLens, KTriggerPanel, KTrigger, KStickyPad, and KPointTrigger. KLensRetractor has an instance of KTrigger. Finally, components that define the Sticky Push as described in section 4 are: KControlLens, KNorthTrigger, KWestTrigger, KEastTrigger, KPushPad, and KStickyPoint.

A.2.1 KControlLens

As shown in FIG. 5-1, KControlLens is derived from KComponent. Important methods of this component are: setControlLens( ), and removeActiveLens( ). Both methods are called by KLensLogic. The method setControlLens( ) sets the new Active Lens in the Sticky Push. Method removeActiveLens( ) removes the Active Lens and returns the Control Lens to its default size.

A.2.2 KNorthTrigger, KWestTrigger, KEastTrigger

The triggers KNorthTrigger, KWestTrigger and KEastTrigger are similar in implementation. Each trigger has instances of a KTrigger and a KTriggerPanel. KTriggerPanel contains the icons associated with the trigger. KTrigger has an inner class called KPenListener. This class listens for the pen to enter its trigger. If the pen enters the trigger and the KTriggerPanel is visible, then the KPenListener will close the panel. Otherwise KPenListener will open the panel. The KPenListener inner class extends MouseListener. This inner class is shown below.

```
private class KPenListener implements MouseListener{
    /** Invoked when the mouse enters a component. */
    public void mouseEntered(MouseEvent e){
      if(triggerPanel.isUnlocked( )){
        if(triggerPanel.changeOpenStatus( ))
          triggerPanel.close( );
        else
          triggerPanel.open( );
      }
    }
  }
```

Important methods in the triggers are: open( ), close( ), and addIcon( ). The open( ) method makes the KTriggerPanel and KIcons visible for the respective trigger. The close( ) method makes the KTriggerPanel and KIcons transparent to appear like they are hidden. Method addIcon( ) allows the triggers to add icons when open and closed dynamically. For example, when PDACentric starts up, the only KIcon on the KWestTrigger is the “Home” icon. When another application, like KRAC, starts up, the KRAC will add its KIcon to the KWestTrigger with the addIcon( ) method.

A.2.3 KPushPad

KPushPad has two instances of KStickyPad, the Right and Left Sticky Pads, and a KLensRetractor. Important methods in KPushPad are: setPenListeners( ), and getActivePushPad( ). The setPenListeners( ) method adds a KPenListener instance to each of the KStickyPads. The KPenListener inner class can be seen below. KPenListener extends MouseListener and listens for the user to move the pen into its boundaries. Each KStickyPad has an instance of KPenListener.

```
class KPenListener implements MouseListener{
  /** Invoked when the mouse enters a component. */
  public KPenListener( ){}
  public void mouseEntered(MouseEvent e){
    switch(((KStickyPad)e.getComponent( )).getPadId( )){
      case RIGHT_PAD:
          rightPad.setBackground(padSelectedColor);
          activePushPad = RIGHT_PAD;
        break;
      case LEFT_PAD:
          leftPad.setBackground(padSelectedColor);
          activePushPad = LEFT_PAD;
        break;
    }
    rightPad.removeMouseListener(penListener);
    leftPad.removeMouseListener(penListener);
    stickyPush.getPushLogic( ).getPushEngine( ).start( );
    stickyPush.getPushLogic( ).activateComponent( );
  }
}
```

The method getActivePad( ) is called by one of the logic components. This method returns the pad currently being pushed by the pen. Knowing which KStickyPad has been entered is necessary for adding heuristics as described for the Right and Left Sticky Pads in section 5.

A.2.4 KStickyPoint

KStickyPoint has two instances of KPointTrigger. The KPointTrigger instances correspond with the vertical and horizontal lines on the KStickyPoint cross-hair. Their intersection is the point that enters KIcons and other controllable components. This class has one important method: setVisible( ). When this function is called, the vertical and horizontal KPointTriggers are set to be visible or not.

A.3 Content

The content component in the PDACentric architecture consists of the components necessary for an application to be controlled by the Sticky Push. As shown in FIG. A-1, three of the classes are derived from KComponent: KPushtopPanel, KZoomPanel and KIcon. KPushtop has instances of KIcon, KPushtopPanel, and KStickyPointListener. KApplication is the interface used to extend and create an application for PDACentric.

A.3.1 KPushtopPanel

KPushtopPanel is derived from KComponent. The pushtop panel is similar to a “desktop” on a desktop computer. Its purpose is to display the KIcons and text for the KApplication. An important method is addIconPushtopPanel( ), which adds an icon to the KPushtopPanel. KPushtopPanel has a Swing FlowLayout and inserts a KIcons from left to right.

A.3.2 KIcon

Abstract class KIcon extends KComponent and provides the foundation for derived classes. Important methods for KIcon are: iconActive( ), iconInactive( ), and isPenEntered( ). Method isPenEntered is required by all classes extending KComponent. However, KIcon is one of the few classes redefining its functionality. The definition of isPenEntered( ) calls the iconActive( ) and iconInactive( ) methods. KIcon's isPenEntered( ) definition is:

```
public void isPenEntered( ) {
    if(pushtop.penEntered(this)){
      setBackground(Color.red);
      pushtop.setIconComponent(this);
      pushtop.setApplicationComponent(application);
      stickyPush.getStatusBar( ).setText(name);
      iconActive( );
    }
    else{
    setBackground(Color.lightGray);
    if(stickyPush.getStatusBar( ).getText( ).equals(name)){
      stickyPush.getStatusBar( ).setText(“”);
    }
    if(pushtop.getIconComponent( ) == this)
      pushtop.setIconComponent(null);
    if(pushtop.getApplicationComponent( ) == application)
      pushtop.setApplicationComponent(null);
    iconInactive( );
  }
}
```

A.3.3 KZoomPanel

This class contains a loadable Active Lens associated with a KIcon. When the KControlLens gets the loadable Active Lens from a KIcon, the KZoomPanel is what is returned and loaded as the opaque Active Lens.

A.3.4 KStickyPointListener

KStickyPointListener is the component that listens to all the KIcons and helps determine what KIcon is active. Important methods for KStickyPointListener are: addToListener( ), setStickyPoint( ), and stickyPointEntered( ). Every KIcon added to the KPushtopPanel is added to a Vector in KStickyPointListener by calling the addToListener( ) method. This method is:

public void addToListener(KComponent kcomponent){
listeningComponent.add(kcomponent);
}

Method setStickyPoint( ) is called by the KPushEngine when the Sticky Push moves.

This method allows KStickyPointListener to know the location of KStickyPoint. Once the location of the KStickyPoint is known, the KStickyPointListener can loop through a Vector of KIcons and ask each KIcon if the KStickyPoint is within its boundary. The KIcons check to see if the KStickyPoint is in its boundary by calling the stickyPointEntered( ) method in KStickyPointListener. These methods are:

```
public void setStickyPoint(int x, int y){
  x_coord = x;
  y_coord = y;
  penEntered = false;
    for(into i =0; i < listeningComponent.size( ); i++)
      ((KComponent)listeningComponent.elementAt(i)).isPenEntered( );
}
public boolean stickyPointEntered(KComponent kcomponent){
  if(isListening){
      Point point = kcomponent.getLocation( );
      into width = kcomponent.getWidth( );
      into height = kcomponent.getHeight( );
      if( (x_coord >= point.x) &&
        (y_coord >= point.y) &&
        (x_coord <= point.x + width) &&
        (y_coord <= point.y + height)){
        return true;
      }
  }
  return false;
}
```

A.3.5 KPushtop

Each KPushtop has one instance of KStickyPointListener and KPushtopPanel, and zero to many instances of KIcon. KPushtop aggregates all necessary components together to be used by an KApplication. Important methods for KPushtop are: setZoomableComponent( ), setApplicationComponent( ), and setIconComponent( ).

The setZoomableComponent( ) and setIconComponent methods set the current active KIcons KZoomPanel and KIcon in the logic layer. If the user decides to load the Active Lens associated with the active KIcon, the KZoomPanel set by this method is returned.

The setApplicationComponent( ) adds a KApplication to the KApplicationLogic class. All applications extending KApplication are registered in a Vector in the KApplicationLogic class.

A.3.6 KApplication

Class KApplication is an abstract class that all applications desiring to be controlled by the Sticky Push must extend. The two abstract methods are: start( ), and setEastPaneIcons( ). Important methods for KApplication are: addIcon( ), setTextArea( ), setBackground( ), and addEastPanelIcon( ).

Method start( ) is an abstract method all classes extending KApplication must redefine. This method is called when a user starts up the KApplication belonging to the start( ) method. The definition of the start( ) method should include all necessary initialization of the KApplication for its proper use with the Sticky Push.

The addEastpanelIcon( ) method is an abstract method all classes extending KApplication must redefine. The purpose of this method is to load KApplication specific icons into the KEastTrigger.

The addIcon( ) method adds a KIcon to the KApplications KPushtopPanel. Method setTextArea( ) adds a text area to the KApplication KPushtopPanel. The setBackground( ) method sets the background for the KApplication. Finally, addEastPanelIcon( ) adds a KIcon to the KEastTrigger.

A.4 Logic

The logic component in the PDACentric architecture consists of all the logic classes. As shown in FIG. A-1, there are four classes in the logic component: KApplicationLogic, KLensLogic, KPushEngine, and KPushLogic. These four components handle all the logic to provide control over the content components. The KPushLogic class initializes KApplicationLogic, KLensLogic and KPushEngine classes. After initialized these three classes perform all of the logic for the content and control components of the architecture.

A.4.1 KPushEngine

Class KPushEngine handles all the resizing and moving of the Sticky Push. Important methods for KPushEngine are: pushStickyPoint( ), pushStatusBar( ), positionComponents( ), setXYOffsets( ), start( ), stop( ), resize( ), setControlLens( ), and shiftPushtopPanel( ).

The pushStickyPoint( ) method moves the KStickyPoint around the screen. This method is called by positionComponents( ). When called the X and Y coordinates are passed in as arguments from the positionComponents( ) method.

The pushStatusBar( ) method moves the KStatusBar around the screen. This method is called by positionComponents( ). When called the X and Y coordinates are passed in as arguments from the positionComponents( ) method.

Method positionComponents( ) relocates all the components associated with the Sticky Push: KControlLens, KPushPad, KNorthTrigger, KWestTrigger, KEastTrigger, KStickyPoint, and KStatusBar. The X and Y point of reference is the upper left hand corner of KPushPad. The initial X and Y location is determined by setXYOffsets( ).

The setXYOffsets( ) method gets the initial X and Y coordinates before the PushEngine starts relocating the Sticky Push with the start( ) method. Once this method gets the initial coordinates, it calls the start( ) method.

The start( ) method begins moving the Sticky Push. This method locks all the triggers so they do not open while the Sticky Push is moving. Then it adds a KPenListener to the Sticky Push so it can follow the pen movements. The KPenListener uses the positionComponents( ) method to get the X and Y coordinates of the pen to move the Sticky Push. The KPenListener class is shown below

```
private class KPenListener extends MouseInputAdapter {
    public void mouseDragged(MouseEvent e) {
      if(pushPad.getActivePushPad( ) > −1){
        positionComponents(e.getX( ), e.getY( ));
      }
    }
    /** Invoked when the mouse enters a component. */
    public void mouseEntered(MouseEvent e){
      setXYOffsets(e.getX( ));
    }
    // Invoked when a mouse button has been pressed on a component.
    public void mouseReleased(MouseEvent e) {
      //set for handheld device
      stop( );
    }
  }
```

The positionComponents( ) relocates all Sticky Push components using the upper left corner of the KPushPad as the initial X and Y reference. This method is called as long as the user is moving the Sticky Push. Once the pen has been lifted from the handheld screen the mouseRelease( ) method is called from KPenListener. This method calls the stop( ) method in KPushEngine.

As shown below, the method stop( ) removes the KPenListener from the Sticky Push and calls the unlockTriggers( ) method. Now the Sticky Push does not move with the pen motion. Also, all triggers are unlocked and can be opened to display the control icons. If a trigger is opened or an opaque Active Lens is loaded into the Control Lens the resize( ) method is called.

```
public void stop( ){
  layeredPane.removeMouseListener(penMotionListener);
  engineMoving = false;
  //notify lenslogic to check for a zoomable component
  pushLogic.activateComponent( );
  pushPad.setPenListeners( );
  unlockTriggers( );
}
```

The resize( ) method resizes all the Sticky Push components based on the width and heights of the triggers or the opaque Active Lens. All components get resized to the maximum of the height and width of triggers or opaque Active Lens.

Method setControlLens( ) is called by the KLensRetractor to make the ControlLens visible or invisible. It calls the setVisible( ) method on all the components associated with the Control lens. The method definition is:

```
public void setControlLens(boolean value){
  northTrigger.setVisible(value);
  westTrigger.setVisible(value);
  eastTrigger.setVisible(value);
  controlLens.setVisible(value);
  stickyPoint.setVisible(value);
  applicationLogic.setStickyPointListener(value);
  statusBar.setVisible(value);
}
```

Finally, the method shiftPushtopPanel( ) is used to determine if the KApplication pushtop is larger than the physical screen size. If it is and the Sticky Push is close to the edge of the screen, then the entire KPushtop will shift in the direction of where the Sticky Push is being moved.

A.4.2 KApplicationLogic

Class KApplicationLogic handles all the logic for KApplications. Important methods for KApplicationLogic are: setApplication( ), startApplication( ), setStickyPointListener( ), and setStickyPoint( ).

Method setApplication( ) sets the KApplication specified as the active KApplication. The startApplication( ) method starts the KApplication. When a new KApplication is started, the KStickyPointListener for the KApplication needs to be set with setStickyPointListener( ). Also, when a new KApplication starts or becomes active the location of the KStickyPoint needs to be set with setStickyPoint( ).

A.4.3 KLensLogic

Class KLensLogic handles all the logic for the KControlLens. Important methods for KLensLogic are: setZoomPanel( ), removeActiveLens( ), and setLensComponent( ).

Method setLensComponent( ) loads the KZoomPanel associated with the current active KIcon as the KControlLens opaque Active Lens. An icon becomes active when the KStickyPoint is within its boundaries. The active KIcon registers its KZoomPanel with the KPushtop. Then KPushtop uses the setZoomPanel( ) method to set the active KZoomPanel associated with the active KIcon in KLensLogic. KLensLogic always has the KZoomPanel associated with the active KIcon. If no KZoomPanel is set, then null is returned signaling no KZoomPanel is present and no KIcon is active.

The removeActiveLens( ) method removes the KZoomPanel from the KControlLens and returns the Sticky Push Active Lens to the default dimensions.

Appendix B

This appendix includes the results of a study performed to evaluate different features of the present invention using a handheld computing embodiment. The comments contained in this appendix and any references made to comments contained herein, are not necessarily the comments, statements, or admissions of the inventor and are not intended to be imputed upon the inventor.

Usability Evaluation Forms, Visual Aids, and Data

This appendix contains a (B.1) user questionnaire form, (B.2) evaluator comment form, (B.3) Sticky Push visual aid, and evaluation data compiled during evaluations with eleven students at the University of Kansas. The evaluation data are: (B.4) Computing Experience Data, (B.5) Functionality Training Questions Data, (B.6) Icon Selection Questions Data, (B.7) Lens Selection Data, (B.8) Navigation Questions Data, and (B.9) Closing Questions Data. Refer to chapter 6 for an evaluation of the data presented in this appendix.

B.1 Sticky Push User Evaluation Questionnaire

Refer to figures: FIG. B-1, FIG. B-2, FIG. B-3, and FIG. B-4.

B.2 Evaluator Comments Form

Refer to FIG. B-5

B.3 Sticky Push Visual Aid

Refer to FIG. B-6

B.4 Computing Experience Questions Data

Refer to tables: Table B-1, and Table B-2

B.5 Functionality Training Questions Data

Refer to tables: Table B-3, Table B-4, Table B-5 and Table B-6

B.6 Icon Selection Questions Data

Refer to tables: Table B-7, Table B-8, Table B-9, Table B-10 and Table B-1

B.7 Lens Selection Questions Data

Refer to tables: Table B-12, Table B-13, Table B-14, Table B-15 and Table B-16

B.8 Navigation Questions Data

Refer to tables: Table B-17, Table B-18, Table B-19, and Table B-20

B.9 Closing Questions Data

Refer to tables: Table B-21, and Table B-22

What is claimed is:

1. A graphical user interface tool comprising:
trigger means that, when activated, cause the graphical user interface tool to display control icons, wherein the control icons cause the graphical user interface tool to perform an operation;
selection means for selecting items in a GUI; and
magnifying means for magnifying at least a portion of a GUI.

2. A graphical interactive pointing guide comprising:
a moveable magnifying lens, wherein the magnifying lens is selectively displayed and retracted from the graphical interactive pointing guide; and
a control providing selectively displayed control objects.

3. The graphical interactive pointing guide of claim 2, wherein the selectively displayed control objects include a North Trigger, an East Trigger, a West Trigger, a Sticky Point, an Active Lens, and Status Bar.

4. An architecture for an interactive pointing guide comprising:
a content layer which displays content the user prefers to view and control with in interactive pointing guide;
a control layer which displays controls to a user; and
an invisible logic layer which provides liaison between the content and control layers and controls the operation of the interactive pointing guide.
